(19) United States
(12) Patent Application Publication
(10) Pub. No.: US 2021/0020263 A1
(43) Pub. Date: Jan. 21, 2021

(54) LATTICE METAMATERIAL HAVING PROGRAMED THERMAL EXPANSION

(71) Applicant: THE ROYAL INSTITUTION FOR THE ADVANCEMENT OF LEARNING/MCGILL UNIVERSITY, Montréal (CA)

(72) Inventors: Damiano PASINI, Montreal (CA); Hang XU, Montreal (CA)

(21) Appl. No.: 16/622,600

(22) PCT Filed: Jun. 14, 2018
(86) PCT No.: PCT/CA2018/050723

§ 371 Date: Dec. 13, 2019

Related U.S. Application Data
(60) Provisional application No. 62/519,530, filed on Jun. 14, 2017.

(51) Int. Cl. G12B 1/02

(52) U.S. Cl. CPC G12B 1/02; B33Y 10/00

(57) ABSTRACT

A metamaterial having a programmed thermal expansion when exposed to a temperature condition is described. The metamaterial includes a lattice structure composed of a plurality of interconnected unit cells, each of the unit cells comprising two or more bi-material building blocks having first material elements and second material elements. The first material elements have a first coefficient of thermal expansion (CTE) and the second material elements having a second CTE, the first CTE being greater than the second CTE. The bi-material building blocks have a topology with two or more vertices formed at junctions between said first material elements and said second material elements. One of the first material elements interconnects and extends between two of the second material elements at the vertices. The first material elements deforming substantially long a longitudinal axis thereof to cause the bi-material building blocks to be stretch-dominated when deforming in response to temperature changes.

### CROSS-REFERENCE TO RELATED APPLICATIONS

The present application claims priority on U.S. Patent Application Ser. No. 626/519,530 filed Jun. 14, 2017, the entire content of which is incorporated herein by reference.

### TECHNICAL FIELD

The present disclosure relates generally to metamaterials, and more particularly to lattice metamaterials having pre-programed thermal expansions and components made of such materials.

### BACKGROUND

Metamaterials are materials engineered (sometimes described as being “designed” or “architected”) to have properties that do not occur naturally. Mechanical metamaterials are “designer” materials with exotic mechanical properties mainly controlled by their unique architecture rather than the chemical make-up of their consistent materials.

While a number of such mechanical metamaterials exist, a need exists to provide improved mechanical metamaterials which can be designed such as to thermally react (i.e. expand or contract) in a desired way, or alternately to be thermally stable, when exposed to predetermined temperature thresholds and/or temperature changes. Such materials will be referred to herein as “tunable” or “programed” thermal expansion materials, because they can be designed in such a manner that they will thermally react in a predetermined manner when exposed to given temperature thresholds and/or temperature changes (which may be collectively referred to herein as a “temperature condition”).

For example, systems used in space are particularly vulnerable to large temperature changes, to which they may be exposed when travelling into and out of the Earth's shadow inter alia. Such large variations in temperature can sometimes lead to undesired geometric changes in sensitive components requiring very fine precision, such as sub-reflectors supporting struts, space telescopes and large array mirrors, for example. Thus, one of the leading markets for tunable thermal expansion materials is the aerospace industry. With the increasing demand of smaller satellites in the industry, the need for more efficient structural designs is unavoidable; this sets high demands for multifunction materials that can accommodate extreme temperature fluctuations.

With this in mind, the demand for improved “tunable” thermal expansion metamaterials is unquestionable. In addition to the above-mentioned aerospace applications, such materials may also be useful for applications in other industries, including, for example but without limitation to, expansion joints for bridges, optical systems in grounded telescopes, biomedical sensors and thermal sensors in MEMS (microelectromechanical systems), etc.

### SUMMARY

The present disclosure accordingly provides lattice metamaterials, both two-dimensional (2D) and three-dimensional (3D), which have thermal expansions that are pre-programed (i.e. “tuned”) by virtue of the physical structure of the lattice materials and the material of the constituent element of the unit cells forming the lattice.

The term “thermal expansion” as used herein is intended to be understood broadly to include both expansion and contraction (i.e. negative expansion) caused by thermal changes, as well as thermal neutrality (i.e. the material is designed to remain unchanged in size/shaped when exposed to temperature changes).

There is accordingly provided hierarchical lattice materials which feature enhanced coefficient of thermal expansion (CTE) “tunability”, regardless of the choice of the constituent solids, and which enable thermal expansion control without incurring in severe loss of structural performance.

In one embodiment, stretch-dominated bi-material unit cells with low-CTE and high-CTE components are described. In one particular embodiment comprise diamond shaped building blocks of hierarchical lattices which enable CTE tunability and structural performance, as well as allowing separate tuning of their thermo-elastic properties.

There is accordingly provided a hierarchical bi-material lattice that is stiff and designed to attain a theoretically unbounded range of thermal expansion without (i) impact onto elastic moduli and (ii) severe penalty in specific stiffness. Through a combination of theory, numerical simulations and experiments, the thermomechanical performance of eight hierarchical lattices, including two fractal-like hierarchical lattices with self-repeating units that are built from dual-material diamond shapes with low and high coefficients of thermal expansion (CTE) is demonstrated.

In one specific embodiment, the achievable range of CTE can be enlarged by about 66% through the addition of one order of hierarchy. For a given CTE range, the specific stiffness can be at least about 1.4 times larger than that of existing stretch-dominated concepts.

Hybrid-type HL architecture including those made of self-repeating unit cells, i.e. fractal-like HL, can be tailored to concurrently provide high specific stiffness and theoretically unbounded CTE tunability with CTE values ranging from large positive, zero to large negative. The hallmark of fractal-like and hybrid-type HL is that they can reduce the penalty that an increase in ΔCTE will generate on the elastic properties, so as to obtain the best compromise out of them. In addition, their stretch-dominated behaviour provides higher specific stiffness than existing concepts that are bend-dominated. Another benefit of hybrid-type HL is that they can be exploited to decouple initially coupled thermo-elastic properties so as to provide the individual property tailoring that current concepts have not been proven to attain yet. The present disclosure can be extended to potentially address other conflicting properties to finally generate trade-off solutions for multifunctional applications, including thermal expansion control, MEMS, biomedical sensors and space optical systems.

In one aspect, a systematic strategy is developed to use triangular (2D) or tetrahedron (3D) tessellation to develop low thermal expansion lattices with low mass and high specific stiffness at levels currently unmet by existing concepts.

Stretching dominated bi-material diamond-shaped (2D) or tetrahedron (3D) lattices with low- or high-CTE, are thus provided which are used as building blocks in hierarchical lattices, with the goal of releasing the trade-off between CTE tunability and structural performance, as well as allowing separate tuning of their thermal and elastic properties.

The concepts can be used not only to tune thermal expansion but also to act as actuation and hence be an alternative to smart actuating materials.

In accordance with one aspect, there is provided bi-material unit cells with both high CTE element(s) and low CTE element(s), the unit cells being used to build hierarchical lattices including those made of self-repeating unit cells, i.e. fractal-like hierarchical lattices and hierarchical lattices which feature at least two unit cells with different topologies, thus making the hierarchical lattice of a hybrid-type. LD and HD as building blocks of fractal-like and hybrid-type HL with the goal of attaining a CTE range that can be theoretically unbound, and if desired this boost can be obtained with no penalty in elastic stiffness.

The present disclosure focuses on unit cell that are stretching dominated and presents a systematic strategy to use triangular (2D) or tetrahedron (3D) tessellation to develop low thermal expansion lattices with low mass and high specific stiffness at levels currently unmet by existing concepts. Furthermore, stretching dominated bi-material diamond-shaped unit cells (2D) or tetrahedron (3D) lattices with low- or high-CTE, have been presented as building blocks in hierarchical lattices with the goal of improving CTE tunability and structural performance, as well as allowing separate tuning of their thermal and elastic properties.

There is accordingly provided a two-dimensional building block element comprising: four diagonal bars connected to one another at their extremities to form a diamond, each of the four diagonal bars having a first coefficient of thermal expansion; and a horizontal bar extending between extremities of the horizontal bar and interconnecting two vertices of the diamond formed by the four diagonal bars by, each extremity connected to opposed connections of the four diagonal bars, the horizontal bar having a second coefficient of thermal expansion different than the first coefficient of thermal expansion.

There is also provided a two-dimensional building block made from a fractal lattice, a replication motif of the fractal lattice comprising: four diagonal bars connected to one another by their extremities to form a diamond, each of the four diagonal bars having a first coefficient of thermal expansion; and a horizontal bar having a second coefficient of thermal expansion different than the first coefficient of thermal expansion, the horizontal bar connected at its extremities to opposed connections of the four diagonal bars.

There is also provided a hybrid two-dimensional building block having a triangular shape, the building block comprising three bars connected to one another at their extremities to form a triangle, each of the three bars being made from the two-dimensional building blocks as defined above, the thermal and structural properties of the hybrid two-dimensional building block being decoupled.

There is also provided a three-dimensional building element having a tetrahedron shape, the building element having six bars, each of the six bars connected to two bars of the six bars at a first extremity and to two other bars of the six bars at a second extremity, at least two of the six bars having a coefficient of thermal expansion different than that of a remainder of the six bars.

There is also provided a three-dimensional building block made from a fractal lattice, a replication motif of the fractal lattice comprising six bars, each of the six bars connected to two bars of the six bars at an extremity and to two other bars of the six bars at another extremity, at least two of the six bars having a coefficient of thermal expansion different than that of a remainder of the six bars.

There is also provided a hybrid three-dimensional building block having a triangular shape, the building block comprising three bars connected to one another at their extremities to form a triangle, each of the three bars being made from the 3D building blocks as defined above, the thermal and structural properties of the hybrid 3D building block being decoupled.

There is herein disclosed systematic routes to program thermal expansion in given directions as required by the application. Concepts of vector analysis are used to express thermal expansion of building blocks and compound units along their principal, or any other, directions. In addition, notions of crystal symmetry are borrowed from crystallography to elucidate the relationship between geometric symmetry and thermal expansion of bi-material lattices assembled from either building blocks or compound units. The proposed framework enables the attainment of three sets of distinct behaviour of directional CTE: (i) unidirectional, (ii) transverse isotropic, and (iii) isotropic. In addition to CTE tun-ability, closed form expressions are provided for the Young's modulus, shear modulus, buckling and yielding strength of unit cells, here introduced to attain a high level of both CTE tunability and structural efficiency.

There is accordingly provided, in accordance with one aspect of the present disclosure, a metamaterial having a programmed thermal expansion when exposed to a temperature condition, the metamaterial comprising a lattice structure composed of a plurality of interconnected unit cells, each of the unit cells comprising two or more bi-material building blocks, each of the bi-material building blocks including one or more first material elements and two or more second material elements, the first material elements having a first coefficient of thermal expansion (CTE) and the second material elements having a second CTE, the first CTE being greater than the second CTE, the bi-material building blocks having a topology each having two or more vertices formed at junctions between said first material elements and said second material elements, one of the first material elements interconnecting and extending between two of the second material elements at said vertices of the topology, said one of the first material elements having the first CTE deforming substantially long a longitudinal axis thereof to cause the bi-material building blocks to be stretch-dominated when deforming in response to temperature changes, and wherein the bi-material building blocks and the unit cells are inter-engaged and tessellated to provide the lattice structure with the programmed thermal expansion when exposed to the temperature condition.

In the metamaterial as defined above, the bi-material building blocks may have a triangular, diamond or tetrahedron shaped topology formed by said first material elements and said second material elements.

In the metamaterial as defined above, the lattice may be two-dimensional and the topology of the bi-material building blocks may include at least one of triangular and diamond shaped topology.

In the metamaterial as defined above, the bi-material building blocks may have a diamond shaped topology, and the one of the first material elements extends transversely through the diamond shaped topology to interconnect two minor vertices thereof.

In the metamaterial as defined above, the lattice may be three-dimensional and the topology of the bi-material building blocks includes a tetrahedron shaped topology.

In the metamaterial as defined above, said one of the first material elements may form at least one edge of the tetrahedron shaped topology.

In the metamaterial as defined above, the first material elements and the second material elements form the bi-material building blocks may include rods that are interconnected at opposed ends thereof to form said topology.

In the metamaterial as defined above, the opposed ends of each of the rods may be pivotably interconnected (e.g. hinged) at the vertices of the topology.

In the metamaterial as defined above, each of the diamond shaped bi-material building blocks may be composed of five rods, at least one of the five rods being made of the first material elements having the first CTE and the remaining rods being made of the second material elements having the second CTE that is lower than the first CTE.

In the metamaterial as defined above, an internal angle defined between said at least one of the five rods made of the first material elements and at least one adjacent of the remaining rods made of the second material elements defined at a vertex therebetween may be between 55 and 65 degrees.

In the metamaterial as defined above, only one of the five rods may be made of the first material element having the first CTE.

In the metamaterial as defined above, each of the five rods may be pivotably connected at ends thereof to adjacent ends of two of the remaining rods.

In the metamaterial as defined above, each of the tetrahedron shaped bi-material building blocks may be composed of six rods connected together to define the tetrahedron shaped bi-material building block having four faces, at least one of the six rods being made of the first material elements having the first CTE and the remaining rods being made of the second material elements having the second CTE that is lower than the first CTE.

In the metamaterial as defined above, only one of the six rods may be made of the first material element having the first CTE.

In the metamaterial as defined above, each of the six rods may be pivotably connected at ends thereof to adjacent ends of two of the remaining rods.

In the metamaterial as defined above, each of the bi-material building blocks may include only one of the first material elements having the first CTE, a remainder of the topology of the bi-material building blocks formed by the second material elements having the second CTE.

In the metamaterial as defined above, the lattice structure may be a hierarchical lattice.

In the metamaterial as defined above, the hierarchical lattice may include a hybrid-type hierarchical lattice, the unit cells of the hybrid-type hierarchical lattice including two or more different unit cell topologies.

In the metamaterial as defined above, the hybrid-type hierarchical lattice may have a skew angle of between 55 and 65 degrees.

In the metamaterial as defined above, the topology of the bi-material building blocks may including two or more different topologies.

In the metamaterial as defined above, the hierarchical lattice may be a fractal-like hierarchical lattice, with self-repeating ones of the unit cells and/or the building blocks forming a replication motif of the fractal-like hierarchical lattice

In the metamaterial as defined above, the hierarchical lattice may have between one and three orders of hierarchy.

In the metamaterial as defined above, each of the four faces of the tetrahedron shaped bi-material building block may be defined by three of the six rods, wherein an orientation of each of the four faces defining a local direction of CTE tunability.

In the metamaterial as defined above, the five rods include four diagonal rods connected to one another at their extremities to form the diamond shaped topology, each of the four diagonal bars having said first CTE, and a transverse rod extending between extremities thereof and interconnecting two vertices of the diamond formed by the four diagonal rods by, each extremity connected to opposed connections of the four diagonal rods, the transverse rod having the second CTE that is less than the first CTE.

In the metamaterial as defined above, a ratio of the first CTE to the second CTE may be between 0.1 and 10.

In the metamaterial as defined above, a difference in CTE between the first CTE and the second CTE may be between 10×10⁻⁶/° C. and 60×10⁻⁶/° C.

In the metamaterial as defined above, a range of CTE (ΔCTE), defined between a lowest CTE value of the lattice structure and a CTE of a solid material having lower thermal expansion, may be between 100×10⁻⁶/° C. and 550×10⁻⁶/° C.

In the metamaterial as defined above, a specific stiffness of the lattice structure, defined as the elastic modulus per mass density thereof, may be between 0.00001 and 0.1.

In the metamaterial as defined above, the first material elements and the second material elements may each selected from the group consisting of aluminum and alloys thereof, titanium and alloys thereof, acrylic, polytetrafluoroethylene (PTFE), and Invar.

In the metamaterial as defined above, the first material elements may be formed of one of aluminum and alloys thereof and PTFE, and the second material elements may be formed of one of titanium and alloys thereof, acrylic, and Invar.

There is further provided, in accordance with another aspect of the present disclosure, a method of forming a metamaterial having a programmed overall coefficient thermal expansion, the method comprising using additive manufacturing to form a lattice structure having a plurality of interconnected unit cells, each of the unit cells comprising two or more bi-material building blocks, each of the bi-material building blocks including one or more first material elements and two or more second material elements, including selecting a first coefficient of thermal expansion (CTE) of the first material elements and a second CTE of the second material elements lower than the first CTE, and selecting a topology for the bi-material building blocks with two or more vertices formed at junctions between said first material elements and said second material elements, and forming the bi-material building blocks such that one of the first material elements interconnects and extends between two of the second material elements at said vertices of the topology, and configuring the bi-material building blocks to have a stretch-dominated thermal response.

Many further features and combinations thereof concerning the present improvements will appear to those skilled in the art following a reading of the instant disclosure.

### BRIEF DESCRIPTION OF THE FIGURES

FIG. 1a-I to III are front elevation views of a two-dimensional bi-material building block having a low thermal expansion, the block is shown before (I) and after (II-III) thermal expansion with the elements unconnected (II) and connected (III);

FIG. 1b-I to III are front elevation views of a two-dimensional bi-material building block having a high thermal expansion, the block is shown before (I) and after (II-III) thermal expansion with the elements unconnected (II) and connected (III);

FIG. 1c-I to II are tridimensional views of a three-dimensional bi-material building block having a stationary node, the block is shown before (I) and after (II) thermal expansion;

FIG. 1d-I to II are tridimensional views of a three-dimensional bi-material building block having a pair of stationary lines, the block is shown before (I) and after (II) thermal expansion;

FIG. 1e-I to II are tridimensional views of a three-dimensional bi-material building block having one stationary line, the block is shown before (1) and after (II) thermal expansion;

FIGS. 2I to V illustrate the fabrication process of a two-dimensional tessalation;

FIG. 3a are front elevation views of a fractal-like hierarchical lattice with second-order hierarchy (n=2) having a low thermal expansion coefficient;

FIG. 3b are front elevation views of a hybrid-type HL having a low thermal expansion coefficient;

FIGS. 4a-b illustrate the thermal expansion coefficient (a) and the structural efficiency (b) of fractal-lie hierarchical lattice in the y-direction as a function of the hierarchical order;

FIGS. 4c-d illustrate the thermal expansion coefficient (c) and the structural efficiency (d) of fractal-like hierarchical lattice in the y-direction as a function of the hierarchical order;

FIGS. 5a-b illustrate the effect of a change in skew angle (a) and relative density (b) of a diamond that attains low-CTE performances on both thermal and elastic properties;

FIGS. 5c-d illustrate the effect of a change in skew angle (c) and relative density (d) of first and second order hybrid-type hierarchical lattice on both thermal and elastic properties when the CTEs are tuned to preserve constant either the Young's modulus (c) or the CTE (d);

FIG. 6a illustrates a comparison of proposed and existing bi-material concepts on the basis of CTE tunability (ΔC_{TE}=Max CTE−Min CTE) for prescribed stiffness of 1 MPa, and specific stiffness (Young's modulus/Density: E/ρ) for given CTE (47.5×10⁻⁶/° C.);

FIG. 6b illustrates the CTE tunability plotted versus structural efficiency of existing concepts along with hybrid-type and fractal-like hierarchical lattice for increasing hierarchical order;

FIG. 7a shows material length vector and thermal displacement vector for a solid material under a temperature change;

FIG. 7b shows a 2D low-CTE triangle in accordance with one embodiment;

FIG. 7c shows a 3D low-CTE tetrahedron in accordance with one embodiment;

FIG. 7d shows steps used to create an assembly of the low-CTE tetrahedra of FIG. 7c forming a unit cell in accordance with one embodiment; the unit cell being shown before and after deformation under a temperature variation;

FIG. 8a shows a monomaterial low-CTE tetrahedron shown in deformed and undeformed states;

FIGS. 8b to 8e show bi-material low-CTE tetrahedra shown in deformed and undeformed states;

FIG. 8f shows a bi-material tetrahedron with intermediate CTE shown in deformed and undeformed states;

FIGS. 8g to 8j show bi-material high-CTE tetrahedra shown in deformed and undeformed states;

FIG. 8k shows a tridimensional view of a monomaterial high-CTE tetrahedron shown in deformed and undeformed states;

FIGS. 9a to 9c show tridimensional views of bi-material tetrahedra in deformed and undeformed state;

FIGS. 9d to 9f are graph illustrating the variation of the CTE in the z-direction in function of the skew angle and in function of the ratio of the CTE of the material of the tetrahedra of FIGS. 9a to 9c, respectively;

FIGS. 9g to 9h are CTE magnitude plotted in polar coordinate system of the tetrahedra of FIGS. 16a to 16c, respectively; FIGS. 10a-10b show a tridimensional view of a screw geometry illustrating a 3-fold axes of symmetry with its top view shown in FIG. 10b;

FIG. 10c shows a top view of building blocks assembled with 3-fold axes;

FIG. 10d shows an axonometric view of the unit cell of FIG. 10c;

FIGS. 11a to 11c show tridimensional views of different variations of unit cells with unidirectional CTE tunability;

FIGS. 11d to 11e show tridimensional views of the unit cells of FIGS. 11a to 11c;

FIGS. 11g to 11i show tridimensional views of the deformed and undeformed of the unit cells of FIGS. 11a to 11c;

FIGS. 11j to 11l show top view of assemblies of the unit cells of FIGS. 11a to 11c;

FIGS. 11m to 110 show axonometric views of the unit cell assemblies of FIGS. 11j to 11l;

FIGS. 11p to 11r show CTE magnitude plotted in polar coordinate system with respect to the principal directions; the semi-axes of each CTE ellipsoid are the CTE coefficients of the unit cell of FIGS. 11j to 11l;

FIGS. 12a to 12c show tridimensional views of different variations of unit cells with transverse isotropic CTE tunability;

FIGS. 12d to 12e show tridimensional views of the unit cells of FIGS. 12a to 12c;

FIGS. 12g to 12i show tridimensional views of the deformed and undeformed of the unit cells of FIGS. 12a to 12c;

FIGS. 12j to 12l show top view of assemblies of the unit cells of FIGS. 12a to 12c;

FIGS. 12m to 12o show axonometric views of the unit cell assemblies of FIGS. 12j to 12l;

FIGS. 12p to 12r show CTE magnitude plotted in polar coordinate system with respect to the principal directions; the semi-axes of each CTE ellipsoid are the CTE coefficients of the unit cell of FIGS. 12j to 12l;

FIGS. 13a to 13c show different variations of unit cells with isotropic CTE tunability;

FIGS. 13d to 13e show tridimensional views of the unit cells of FIGS. 13a to 13c;

FIGS. 13g to 13i show tridimensional views of the deformed and undeformed of the unit cells of FIGS. 13a to 13c;

FIGS. 13j to 13l show top view of assemblies of the unit cells of FIGS. 13a to 13c;

FIGS. 13m to 13o show axonometric views of the unit cell assemblies of FIGS. 13j to 13l;

FIGS. 13p to 13r show CTE magnitude plotted in polar coordinate system with respect to the principal directions; the semi-axes of each CTE ellipsoid are the CTE coefficients of the unit cell of FIGS. 13j to 13l;

FIGS. 14a and 14b show tridimensional views of building blocks made of Al6061 and TI-6Al-4V;

FIGS. 14b and 14d show tridimensional assembly drawings of the building blocks of FIGS. 14a and 14b;

FIG. 14e show a tridimensional view of a building block made with rigid joints and being made of acrylic and PTFE for the bars and ABS for the joints;

FIG. 14f is tridimensional view of an assembly drawing of the building block of FIG. 14e;

FIG. 14g is shows tridimensional views of the joint of FIG. 14e;

FIG. 14h shows a tridimensional view of a testing sample of a building block with black and white pattern for DIC testing;

FIG. 15a is a graph illustrating predicted curve and experimental results of effective CTE for Al/Ti and Al/Invar building blocks (TL-2 and TN) within a range of skewness, along with the CTE of the solid materials;

FIG. 15b is a graph illustrating predicted and experimental CTE results along the principal directions for the concepts with unidirectional CTE and principal directions within the plane x1-x2 for other concepts here examined;

FIG. 16 are graphs illustrating normalized specific stiffness in the vertical direction for TL-1, TL-2, and TN building blocks as a function of the skew angle for selected values of the stiffness ratio of the components (Eₛ₂/Eₛ₁): Young's modulus (FIG. 16a) and shear modulus (FIG. 16b); ρ* representing the relative density;

FIG. 17 is a graph illustrating the relation between the CTE and the skew angle of the unit cells of FIGS. 8b to 8j;

FIGS. 17a to 17i are contour plots representing the effective stiffness in the CTE tunable direction of the unit cells of FIGS. 8b to 8j and of a benchmark;

FIG. 18a is a graph showing comparison of proposed and existing bi-material concepts for given bar thickness ratio of 0.04 on the basis of (i) CTE tunability shown as bars on the left for Young's modulus in the CTE tunable direction, and (ii) specific stiffness for prescribed shown as bars on the right;

FIG. 18b is a graph showing CTE tunability of the building blocks of FIGS. 8b to 8j plotted versus structural efficiency compared to a benchmark;

FIG. 19a shows a tridimensional view of a tetrahedron with low-CTE having four low-CTE bars and two high-CTE bars;

FIGS. 19b to 19d show tridimensional views of unit cells constructed from the low-CTE tetrahedron shown in FIG. 19a

FIG. 19e show a tridimensional view of a tetrahedron with intermediate CTE;

FIGS. 19g to 19h show tridimensional views of unit cells constructed from the building block of FIG. 19e;

FIGS. 20a to 20d show tridimensional views of low-CTE unit cells with transverse isotropic CTE tunability;

FIGS. 20e to 20h show axonometric views of the unit cells of FIGS. 20a to 20d;

FIGS. 20i to 20l show to views of the unit cells of FIGS. 20a to 20d;

FIG. 21a is a graph showing the effective CTE in function of the skew angle for the TL-2 concept;

FIG. 21b is a graph showing the effective CTE in function of the skew angle for the TN concept;

FIG. 22 are tridimensional views showing the structural hierarchy of a 3D lattice having a low thermal expansion coefficient;

FIG. 23 is a graph illustrating the coefficient of thermal expansion as a function of the hierarchical order of the lattice of FIG. 5;

FIGS. 24a to 24h illustrate the method to build a bi-material Octet cell;

FIGS. 25a to 25c illustrate fractal-like hierarchical lattice with n=0 (a); n=1 (b); and n=2 (c) and a thermal deformation field in the x-direction (col. III) and y-direction (col. IV), cols. I and II show the initial configurations for designed and fabricated samples, respectively;

FIGS. 26a to 26c illustrate hybrid-type hierarchical lattice with skew angle of 55 degrees (a), 60 degrees (b), and 65 degrees (c) and thermal deformation field in the x-direction (col. III) and y-direction (col. IV), cols. I and II illustrate initial configurations for designed and fabricated samples, respectively; and

FIGS. 27a to 27c illustrates hybrid-type hierarchical lattice with wall layers of M=1 (a), M=2 (b), and M=3 (c) and thermal deformation field in the x-direction (col. III) and y-direction (col. IV), cols. I and II illustrate initial configurations for designed and fabricated samples, respectively.

### DETAILED DESCRIPTION

Architected materials can be designed to elicit extreme mechanical properties, often beyond those of existing solids. They may be very appealing for use in several fields of engineering including aerospace, automotive and biomedical. In these applications, the target to maximize might be either structural, through attaining for example minimum mass at maximum stiffness, or functional, such as thermal dimension control, heat transfer, band gaps, mechanical biocompatibility, and others. For lightweight structural applications, high stiffness is desired for preserving the structural integrity and resisting a variety of loading conditions. In contrast, high compliance is required to adapt under other loading conditions for more functional applications, such as energy absorption. For functional applications, an architected metamaterial having a coefficient of thermal expansion (CTE) that is specifically designed to provide at least one of a large positive, zero or negative CTE via material architecture tuning.

The design freedom to adjust thermal expansion is particularly advantageous in a large assortment of applications. On one hand, in extreme thermal environments, sensitive applications that require very fine precision, such as satellite antennas, space telescopes, and large array mirrors, call for materials with zero CTE so as to avoid undesired thermal deformation. On the other hand, there are other applications requiring materials with large positive or negative CTEs. These materials must induce responsive and desirable deformations under given changes in temperature, often, but not always, dictated by the surrounding environment, such as in morphing and adaptive structures, as well as MEMS.

The potential of periodic architected materials is also appealing because their repeating cell can be designed to concurrently maximize multiple performance requirements, notably structural and functional. Among many, examples of multifunctional lattices include those developed for aerospace components that can maintain precise dimensional tolerances under large temperature fluctuations and specific stiffness requirements.

In the present disclosure, the focus is on multifunctional lattices designed with the objective of providing unique control of thermal expansion and structural performance. The present disclosure deals with material architectures made of two materials, which can be designed to compensate the mismatched thermal deformation generated by each of the two materials. If exploited, this strategy enables the attainment of an overall thermal deformation that can be large positive, zero or large negative. Since dual material architectures achieve a tunable CTE through a purely mechanical, and thus temperature-independent, mechanism, their CTE is extremely dependent on the unit cell architecture and on the difference in CTE of their constituent solids. To assess the potential of a given architected material in providing a range of CTE values via tailored selection of its material constitutes and its cell topology, we need a quantitative metric. CTE tunability, (ΔCTE), has been recently used to measure the maximum range of CTE values that a concept can achieve upon changes of its unit cell geometry from a given pair of materials. Whereas a single material has only one CTE value, hence no ΔCTE, the CTE of dual material concepts can be adjusted by geometric manipulation of the building block with the result of obtaining a range of CTE values. The difference between the minimum and maximum CTE that an architected material can offer is defined as ΔCTE. For a given concept, a large ΔCTE indicates ample freedom to tune the unit cell geometry, an asset that can release the dependence on the CTE ratio of the constituents.

Preserving high specific stiffness in a dual-material construction has to date been thought to be in conflict with the need of enhancing ΔCTE. The stretch-dominated unit cells constructed by dual-material triangle (2D) or tetrahedron (3D), as described herein, are however believed to enable reducing the penalty that an increase in ΔCTE typically generates on the elastic properties of the material.

Structural hierarchy is one factor governing high stiffness, strength, and toughness in both natural and bio-inspired materials, and even more recently in the field of thermal expansion. However, how to exploit structural hierarchy to, first, amplify CTE tunability in architected materials, and then to decouple physical properties that are in conflict, will be described herein.

The design freedom to adjust thermal expansion is particularly advantageous in a large assortment of applications that require responsive and desirable deformations, including zero thermal expansion, under given changes in temperature.

All existing concepts have a trade-off caused by the inherent thermo-elastic coupling that they feature, a condition that makes desired changes in thermal expansion penalize elastic stiffness, and vice versa.

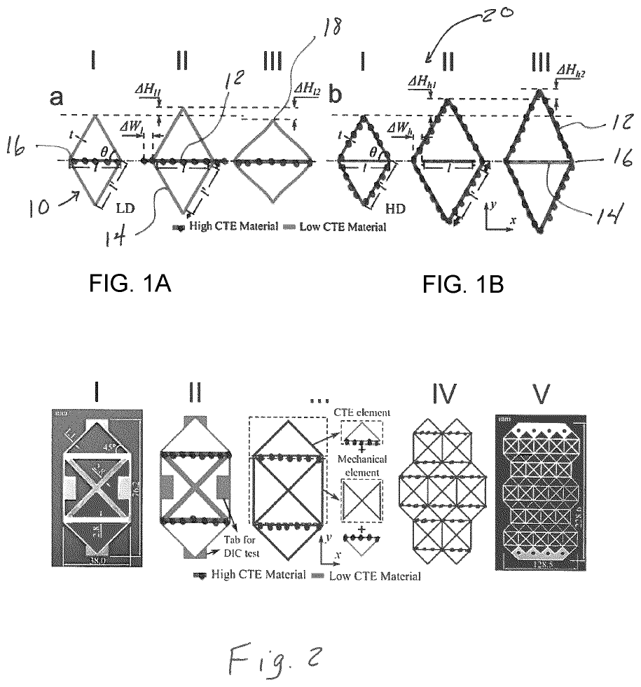

Referring now to FIG. 1a, the mechanical mechanism of thermal expansion of the basic building blocks that can attain a low-CTE performance (LD) is illustrated. The elements are shown as unconnected in FIG. 1a-II for clarification purposes. In the illustrated embodiment, the building block is a diamond 10 that comprises elements 12 composed of a high CTE material and elements 14 composed of a low CTE material. At FIG. 1a-I, the diamond is shown at its original position. In FIG. 1a-II, the elements 12 and 14 of the diamond 10 are not bounded with one another. Upon a uniform increase of temperature, elements 12 (αₛ₁) and 14 (αₛ₂) in the diamond 10 deform at different rates. The height increase, ΔHₗ₁, is caused solely by thermal expansion in elements 14.

Now referring to FIG. 1a-III, the elements 12 and 14 of the diamond 10 are bounded with one another. Hence, in this configuration, rigid connections at the nodes (or vertices) 16 cause a higher expansion in the horizontal bar, or elements 12, that turns the elements 14. As a result, the top vertex 18 of the diamond 10 springs back by ΔHₗ₂, a displacement that if desired can be conveniently designed to compensate ΔHₗ₁. By harnessing the values of the CTE αₛ₁ and αₛ₂, or the skewness of the elements 14, 0, the CTE of a LD 10 might be tuned to zero, or even negative, in the y-direction.

Now referring to FIG. 1b, a building block in the form of a diamond 20 having a shape similar to the diamond 10 of FIG. 1a is illustrated at rest. However, the material distribution of elements 12 and 14 is switched to yield a high-CTE diamond (HD) 20. The expansion of the elements 12 bring about a height increase, ΔHₕ₁, and a width-wise gap, ΔWₕ, which would appear if the element 14, which exhibits less expansion, were visualized as unconnected at nodes 16. Rigid connections at the nodes 16 would compensate the visualized horizontal gap, ΔWₕ, by a height increase of ΔHₕ₂, adding on to ΔHₕ₁, and this value of ΔHₕ₂ can also be tuned by manipulating the CTE αₛ₁, αₛ₂ and the skewness θ. This bi-material building block therefore has a diamond shaped topology, wherein a first material element 14 extends transversely through the diamond shaped topology to interconnect two “minor” vertices 16 (i.e. the two vertices of the diamond that are closest together to define the narrow width of the diamond) thereof.

Hence, in the depicted embodiment, the CTE in the y-direction depends on the thermal expansion ratio of the constituent materials, ξ=αₛ₂αₛ₁, and the skewness angle, θ. If θ is given, the smaller the ξ, the lower (for LD) or higher (for HD) the CTE; hence the greater the CTE distinction of the constituent solids, the higher the CTE tunability.

Now referring to FIG. 1c, in 3D, the building blocks shown as tetrahedron 30 before (I) and after the thermal expansion (II) are shown. Triangular (2D) or tetrahedron (3D) tessellation with these building blocks is applied to develop low thermal expansion lattices with low mass and high specific stiffness at levels currently unmet by existing concepts.

Below is examined the general case of a LD 10 (FIG. 1a-I) with an arbitrary skew angle, θ, and its Young's moduli is derived, from which those for HD 20 can also be obtained. A small thickness ratio is considered, t/l<⅛, that gives LD a low relative density, ρ*/ρₛ, which is defined as the ratio of its real density over the density of the solid. For a generic dual-material unit cell, the relative density can be expressed as a function of the volume fractions of the constituents, and more specifically for a LD can be written as:

$$\frac{{ρ}^{*}}{{ρ}_{s}} = \frac{cos θ + 2}{sin θ} \frac{t}{l} \qquad ( A1 )$$

Using structural mechanics, the in-plane Young's moduli can be derived as:

$$\begin{matrix}\frac{{E}_{y}^{*}}{{E}_{s 2}} = {( \frac{1}{2 {sin}^{3} θ} + \frac{{E}_{s 2} \text{/} {E}_{s 1}}{{tan}^{3} θ} )}^{- 1} \frac{t}{l} & ( A2 ) \\ \frac{{E}_{x}^{*}}{{E}_{s 2}} = \frac{{E}_{s 1} \text{/} {E}_{s 2}}{tan θ} \frac{t}{l} & ( A 3 )\end{matrix}$$

where Eₛ₁ and Eₛ₂ are the Young's modulus for solid materials 1 and 2, respectively. We note that although Eqs. (A2) and (A3) are valid for a defect-free lattice in a fully undeformed state, the thermal deformation and fabrication imperfections, which are less than ±1% of the bar length deviation, will not significantly reduce the elastic moduli (no more than 5%). Even under the largest achievable temperature changes considered herein (ΔT=50° C.), the thermal deformation remains small, thereby causing no significant impact on the elastic moduli.

Since the thermal expansion mismatch between the constituent materials cause bar bending, the effective CTE in the y-direction can be written as:

$${α}_{y}^{*} = {α}_{s 2} + ( \frac{cos θ}{2} - \frac{1}{8 cos {θ ( t / l )}^{2}} ) \frac{{α}_{s 1} - {α}_{s 2}}{{sin}^{2} θ \text{/} ( 8 {cos}^{3} {θ ( t \text{/} l )}^{2} ) + cos θ \text{/} 2 + {( {E}_{s 1} \text{/} {E}_{s 2} )}^{- 1}} \qquad ( A4 )$$

Similarly in the x-direction, the effective CTE is:

$${α}_{x}^{*} = {α}_{s 1} - \frac{{α}_{s 1} - {α}_{s 2}}{( {sin}^{2} θ ( {E}_{s 1} \text{/} {E}_{s 2} ) ) \text{/} ( 8 {cos}^{3} {θ ( t \text{/} l )}^{2} ) + cos θ ( {E}_{s 1} \text{/} {E}_{s 2} ) \text{/} 2 + 1} \qquad ( A5 )$$

Eq. (A4) can be simplified as:

α_{y}*=αₛ₂+k_{CTE}(αₛ₁−αₛ₂) (A6)

where k_{CTE}=(cos θ/2−(8 cos θ(t/l)²)⁻¹)(sin θ/8 cos³ θ(t/l)²+cos θ/2+(Eₛ₁/Eₛ₂)⁻¹)⁻¹ has always a negative value. The LD 10 and HD 20 cases can be specified by the difference in values of the two solid CTEs. If αₛ₁>αₛ₂, α_{y}* is less than the lowest CTE of the two solids (i.e. αₛ₂), thus representing LD FIG. 1a-I). On the other hand, if αₛ₂>αₛ₁ then α_{y}* is larger than the highest CTE—in this instance αₛ₂—which corresponds to the HD case (FIG. 1b-I).

In Eqs. (A4) and (A5) above, the effective CTE is also governed by the geometric parameters of the lattice, namely t/l and θ. The stiffness can also be expressed similarly to the CTE, since they are contingent on the same set of geometric parameters (i.e. t/l and θ in the Eqs. (A2) and (A3)). From this, it appears that a change of this set of parameters would make both the CTE and stiffness vary. How to avoid this thermo-elastic coupling is illustrated below, after how to enlarge ΔCTE in architectures made of any pair of materials is explained.

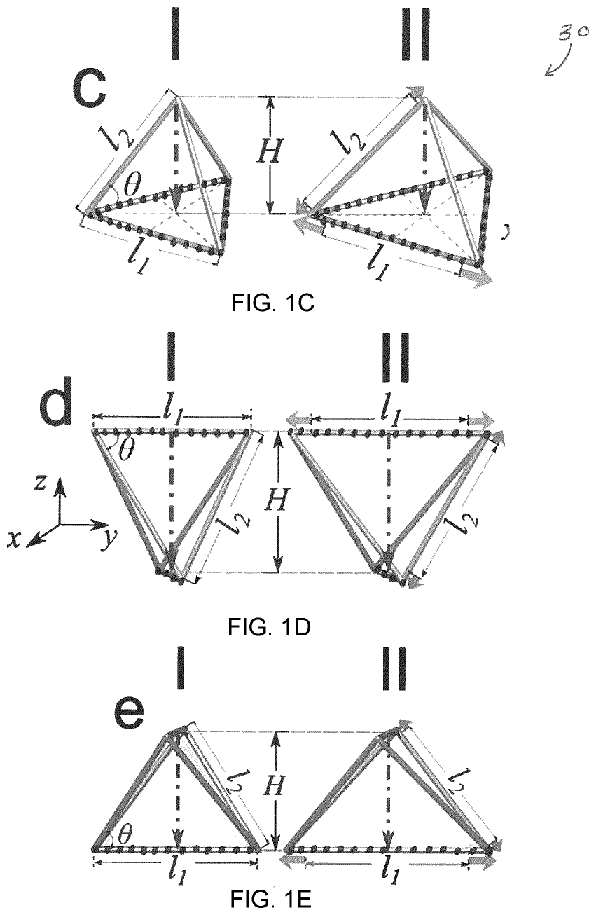

Now referring to FIG. 2, to verify the triangulation strategy as well as the model predictions, one planar bi-material lattice, fabricated as a proof-of-concept from laser cutting, is examined herein. The low-CTE diamond 10 (FIG. 1a) is separated into two triangles and, by incorporating mechanical elements, the proof-of-concept's CTE can reach about 1.3×10-6/° C. with a Young's modulus of about 1.8 GPa in y-direction. In the illustrated embodiment, the high CTE material is Al 6061 and the low CTE material is Ti-6Al-4V. Other suitable material may be used. Horizontal elements are made of the high CTE material. The assembly of unit cells (5 by 5) is illustrated in FIG. 2V.

Now referring to FIG. 3, the LD 10 and HD 20 (FIG. 1) unit cells introduced above can be used as building blocks to create multiscale self-repeating lattices (fractal-like hierarchical lattice) with potentially unbounded range of CTE without severe penalty in specific stiffness. This can provide better trade-off between thermal and mechanical performance. This performance is achieved with neither change of their constituent materials nor manipulation of their skew angles. The underlying principle here is that by replacing the solid constituents with unit cells with higher (HD) and lower (LD) CTE values than those of their base materials, ΔCTE may be amplified.

The stretch-dominated bi-material diamond-shaped unit cells with low- (LD) and high-CTE (HD) 10 and 20 (FIG. 1) introduced above are proposed as building blocks to create multiscale self-repeating fractal-like hierarchical lattice 60 (FIG. 3a) with a potentially unbounded range of CTE. The strategy here described can be used to create fractal-like HL with anisotropic positive or negative thermal expansion, either lower or higher than the CTEs of the constituent materials, as well as high structural efficiency originating from the stretch-dominated cells they are built from. Thus the strategy might provide better trade-off between thermal and mechanical performance than existing concepts. FIG. 3b illustrates an example of hybrid-type hierarchical lattice 70 with two levels of hierarchy. A change in unit cell shape, i.e. a triangle, is implemented at n=2 to show how hierarchy can be effective in not only decoupling but also tuning thermo-elastic properties.

Still referring to FIG. 3, the low-CTE example of fractal-like hierarchical lattice 60 with two hierarchical orders, each constructed through the tessellation of LD 10 and HD 20 with prescribed internal angle θ=60°, is shown. The reverse performance case, i.e. higher CTE, can be obtained by a switch of HD and LD positions. Higher orders can be introduced to reduce or enlarge the effective CTE in desired directions with high structural efficiency (E/φ originating from the stretch-dominated cell this fractal-like hierarchical lattice is built from.

For the analysis, we consider the general case of n^{th} order fractal-like HL of density ρₙ*, effective Young's modulus Eₙ*, and effective CTE αₙ*. The cell walls consist of LD and HD cells of density, ρₙ₋₁*, effective Young's modulus, Eₙ₋₁*, and effective CTE, αₙ₋₁*. The skew angle θ is given and common to all hierarchical orders, whereas the thickness ratios tᵢ/lᵢ are different. The relative density for the general case of fractal-like HL with n orders is:

$$\frac{{ρ}_{n}^{*}}{{ρ}_{s}} = {( \frac{cos θ + 2}{sin θ} )}^{n} ( \frac{{t}_{n}}{{l}_{n}} ) ⋯ ( \frac{{t}_{2}}{{t}_{1}} ) ( \frac{{t}_{1}}{{l}_{1}} ) = {( \frac{cos θ + 2}{sin θ} )}^{n} {\prod }_{i = 1}^{n} ( \frac{{t}_{i}}{{l}_{i}} ) \qquad ( A7 )$$

The Young's modulus of the high- and low-CTE fractal-like HL in the y-direction can be expressed as:

$$\{ \begin{matrix}\frac{{E}_{l , y , i}^{*}}{{E}_{l , y , i - 1}^{*}} = {( \frac{1}{2 {sin}^{3} θ} + \frac{{E}_{l , y , i - 1}^{*} \text{/} {E}_{h , y , i - 1}^{*}}{{tan}^{3} θ} )}^{- 1} \frac{{t}_{i}}{{l}_{i}} \\ \frac{{E}_{h , y , i}^{*}}{{E}_{l , y , i - 1}^{*}} = {( \frac{{E}_{l , y , i - 1}^{*} \text{/} {E}_{h , y , i - 1}^{*}}{2 {sin}^{3} θ} + \frac{1}{{tan}^{3} θ} )}^{- 1} \frac{{t}_{i}}{{l}_{i}} \end{matrix} ( \begin{matrix}1 \leq i \leq n , \\ {E}_{h , y , 0}^{*} = {E}_{sh} , \\ {E}_{l , y , 0}^{*} = {E}_{sl} \end{matrix} ) \qquad ( A8 )$$

where h and l represent the high- and low-CTE, respectively, and i represents the hierarchical order, such that E_{l,y,i}* is the effective Young's modulus of the low-CTE element in the i^{th} order and the y-direction. Their effective CTEs are given by:

$$\{ \begin{matrix}{α}_{l , y , i}^{*} = {α}_{l , y , i - 1}^{*} + ( \frac{cos θ}{2} - \frac{1}{8 cos {θ ( {t}_{i - 1} \text{/} {l}_{i - 1} )}^{2}} ) \frac{{α}_{h , y , i - 1}^{*} - {α}_{l , y , i - 1}^{*}}{\begin{matrix}\begin{matrix}{sin}^{2} {θ ( {t}_{i - 1} \text{/} {l}_{i - 1} )}^{- 2} \text{/} \\ 8 {cos}^{3} θ + cos θ \text{/}\end{matrix} \\ 2 + {E}_{l , y , i - 1}^{*} \text{/} {E}_{h , y , i - 1}^{*}\end{matrix}} \\ {α}_{h , y , i}^{*} = {α}_{h , y , i - 1}^{*} + ( \frac{cos θ}{2} - \frac{1}{8 cos {θ ( {t}_{i - 1} \text{/} {l}_{i - 1} )}^{2}} ) \frac{{α}_{l , y , i - 1}^{*} - {α}_{h , y , i - 1}^{*}}{\begin{matrix}\begin{matrix}{sin}^{2} {θ ( {t}_{i - 1} \text{/} {l}_{i - 1} )}^{- 2} \text{/} \\ 8 {cos}^{3} θ + cos θ \text{/}\end{matrix} \\ 2 + {E}_{h , y , i - 1}^{*} \text{/} {E}_{l , y , i - 1}^{*}\end{matrix}}\end{matrix} \qquad ( A9 )$$

with 1≤i≤n, α_{h,y,0}=αₛₕ, α_{l,y,0}=αₛₗ, E_{h,y,0}*=Eₛₕ, and E_{l,y,0}*=Eₛₗ.

The relations above show that fractal-like HL 60 of any hierarchical order possesses anisotropic thermo-elastic properties that are coupled. Isotropic (planar) behaviour can be attained by changing cell shapes among structural order, i.e. by creating hierarchical lattices, with shapes that exhibit isotropy. This strategy is applied below and self-repeating lattices that are shaped at the last order with cell geometry dissimilar than those of the preceding orders, so as to create hybrid-type HL 70, are considered.

FIG. 3b illustrates an example of hybrid-type HL 70 with two levels of hierarchy. A change in unit cell shape, i.e. a triangle, is implemented at n=2 to show how hierarchy can be effective in not only decoupling but also tuning thermo-elastic properties. As opposed to the fractal-like HL 60 in FIG. 3a, which contains both LD and HD, in FIG. 3b only LD 10 (FIG. 1) is used at n=1 to create a triangle hierarchical lattice with low-CTE, whereas its high-CTE counterpart can be obtained by swapping the material position. We shape a hybrid-type HL 70 at n=2 with a triangle to infer isotropic (planar) mechanical properties and control thermal expansion with LD at n=1. This strategy might be effective in achieving desired levels of property decoupling which can be readily extended to lattices of higher hierarchical order and beyond CTE and stiffness, such as CTE and strength, CTE and Poisson's ratio, thermal-conductivity and Poisson's ratio, and others.

Let's examine hybrid-type HL 70 with n=2 as illustrated in FIG. 3b. If the 2nd order consists of LD 10 (FIG. 1) only, then its overall effective CTE, α₂*, is equal to the CTE of LD in the axial direction (y-direction in the current case), which can be simply expressed as α₂*=α_{1y}*. This shows that α₂* is not dependent on any changes in geometry at the 2nd order, such that θ₂ and t₂/l₂ have no influence on the effective CTE of the overall hybrid-type HL 70. However, any geometric changes at the first order, such as the skew angle, will affect not only α_{1y}* but also the CTE of the overall hybrid-type HL 70, i.e. α₂. With respect to elastic stiffness for hybrid-type HL 70, the normalized effective Young's modulus E₂*/E₁* of the 2nd order, which is mainly a function of unit cell topology, nodal connectivity, cell wall angle, and relative density, ρ₂*/ρ₁*, can be expressed through the wall thickness ratio, t₂/l₂ as:

$$\frac{{E}_{2}^{*}}{{E}_{1}^{*}} = {{k}_{2} ( \frac{{t}_{2}}{{l}_{2}} )}^{q} \qquad ( A10 )$$

Where k₂ is a function of the cell topology adopted at the 2nd order of hybrid-type HL; q depends on the cell wall deformation mode of the 2nd order—stretching or bending—and can assume values that depend on the scaling condition applied to the cell wall cross-section. If E₁* is given, the stiffness of the 2nd order is merely a function of the geometry at the 2nd order and any geometric change at this order will not influence the overall CTE of hybrid-type HL.

The thermal and mechanical 2D isotropic behaviour of the hybrid-type HL 70 in FIG. 3b derives from the shape of the unit cell, in this case a triangle. The relevant properties of hybrid-type HL 70 at n=1 are given in Eqs. (A1), (A2), and (A4), and the mechanical properties at n=2 (θ₂=60°) in Eqs. (A11) and (A12). Since the CTE of the last order hybrid-type HL 70, α₂*, is equivalent to that of the preceding order, in this example the CTE of LD, or HD for the high-CTE case, the thermomechanical properties of hybrid-type HL are given by:

$$\begin{matrix}\frac{{ρ}_{2}^{*}}{{ρ}_{1}^{*}} = 2 \sqrt{3} \frac{{t}_{2}}{{l}_{2}} & ( A11 ) \\ \frac{{E}_{2}^{*}}{{E}_{1 y}^{*}} = \frac{2 \sqrt{3}}{3} \frac{{t}_{2}}{{l}_{2}} & ( A 12 ) \\ {α}_{2}^{*} = {α}_{1 y}^{*} & ( A 13 )\end{matrix}$$

To demonstrate CTE tuning that brings no change in the elastic properties of hybrid-type HL, we seek in its first order a set of pairs for the skew angle θ₁ and t₁/l₁ that can satisfy the condition of constant E_{1y}*. This can be achieved by rearranging Eq. (A4) to find the expression of E_{1y}* that is governed by t₁/l₁ and θ₁, and whose solution provides CTE values at the first order, α₁*, that change with the skew angle but leave E_{1y}* substantially unaltered. This strategy substantially preserves the Young's moduli in the second order and allows CTE tuning in the first order. Furthermore, this scheme enables to construct hybrid-type HL 70 with tunable stiffness via changing wall thickness at the second order, t₂/l₂, while keeping the overall CTE α₂* constant, hence allowing thermo-elastic decoupling.

The explanation given above is of course demonstrative for hybrid-type HL of 2 orders. If n>2 and hybrid-type HL has the triangle at the last (nth) order, the scheme still holds and enables to decouple CTE from elastic stiffness. In this case, the first order to the (n−1)th order are made of low-CTE fractal-like HL; and the relative density and thermo-elastic properties of the highest order can be expressed using Eqs. (A11) to (A13) by replacing 2nd order terms with nth order terms and 1st order with (n−1)th order. The effective properties ρₙ₋₁*, Eₙ₋₁*, and αₙ₋₁* in those general equations can be calculated through Eqs. (A7), (A8) and (A9), respectively.

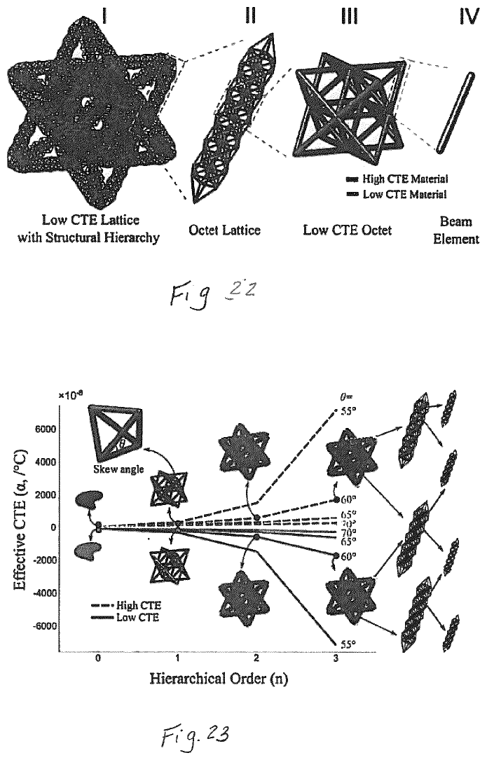

Now referring to FIG. 22, a tridimensional hierarchy lattice with tunable CTE is illustrated. In a particular embodiment, the two order hierarchical lattice can provide design freedom to decouple thermo-elastical properties.

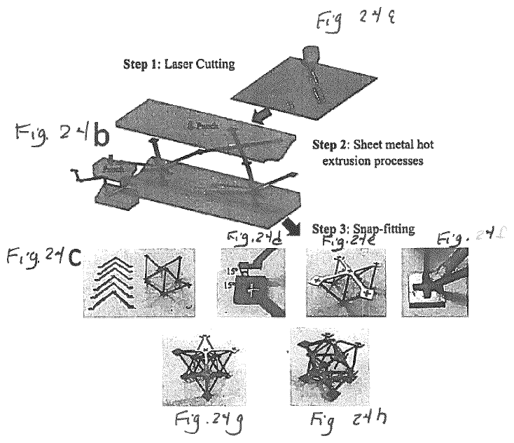

Now referring to FIG. 23, the graph shows that the range of CTE values of a tridimensional lattice increases with its hierarchical order (n).

Now referring to FIG. 24a-24h, in the illustrated embodiment, the bi-material Octect cell (FIG. 22-II) is built using the pretension snap-fit technique. Other techniques, such as, but not limited to, 3D printing, can be conveniently used to build these materials at multiple length scale from the nano to the meter scale. First, laser cutting is used to cut a shape in a sheet metal or other suitable material. Second, a given skew angle is imposed using sheet metal hot extrusion processes. Third, the diagonal elements are snap-fitted. As illustrated in FIG. 24d, a wedge is used for pretension. Then, the horizontal elements are snap-fitted and the joints are reinforced using epoxy glue or other suitable material. FIGS. 24g and h show the octet cell assembly using unbended and slightly bended elements, respectively.

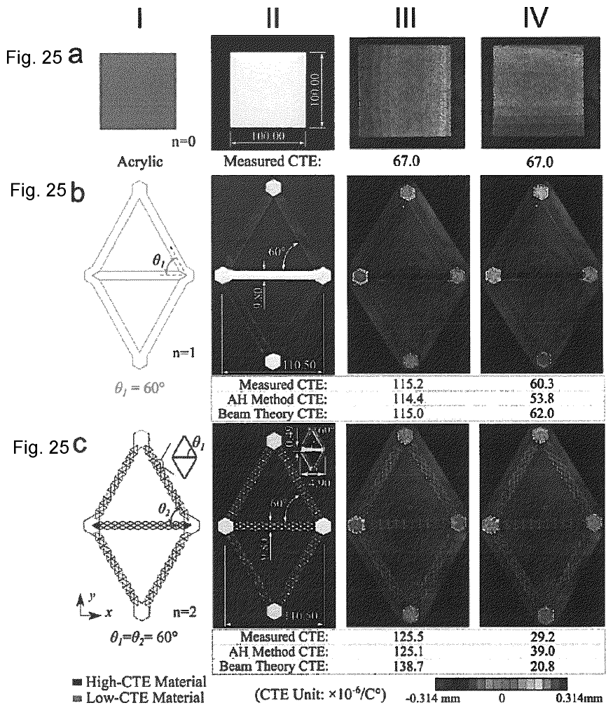

FIGS. 25a to 27c illustrate three sets of experimental validation for the prediction models presented earlier. The validations are performed on laser cut prototypes of hierarchical lattices. Given the scheme presented here is material selection free, a representative pair of materials is chosen to fabricate the samples. In a particular embodiment, the materials are Teflon® Polytetrafluoroethylene (PTFE, DuPont, USA), and acrylic plastic (Polymethyl Methacrylate (PMMA), Reynolds Polymer, Indonesia). Other suitable materials may be used. The properties of these materials are disclosed in Table 1 below. Nevertheless, the experimental validation here provided can be applied to lattices made of any pair of solids including metals, such as Al6061 and Ti-6Al-4V, and for hierarchical orders above 2.

TABLE 1
Predicted and experimentally measured CTE values (×10⁻⁶/° C.) for solid materials.

| | Measured | Measured CTE | CTE provided | Difference | Young's | Density |
|---|---|---|---|---|---|---|
| Material | CTE (DIC) | (TMA Q400) | by the supplier | (%) | Modulus (GPa) | (g/cm3) |
| Acrylic | 67.0 [symbol] 0.5 | — | 69.0 | 2.9% | 3.2 | 1.2 |
| (Low CTE | | | | | | |
| component) | | | | | | |
| Teflon ® PTFE | 123.0 [symbol] 0.9 | — | 120.0 | 2.5% | 0.475 | 2.2 |
| (High CTE | | | | | | |
| component) | | | | | | |
| Al6061 | 22.6 [symbol] 0.4 | 23.0 | — | 1.7% | — | — |

[symbol]

indicates data missing or illegible when filed

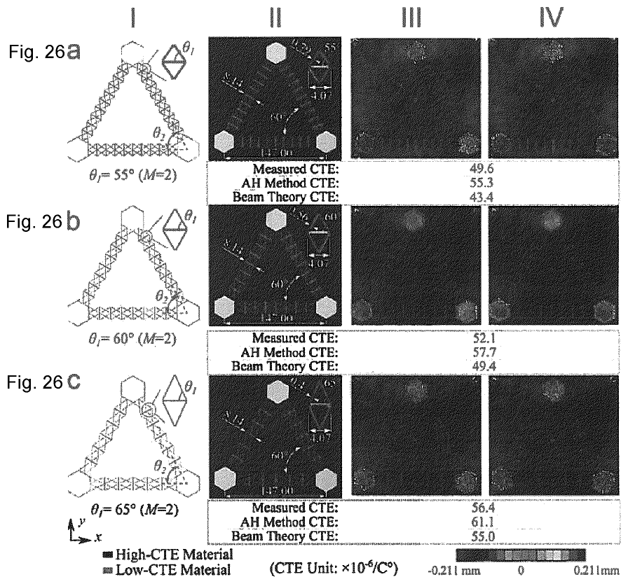

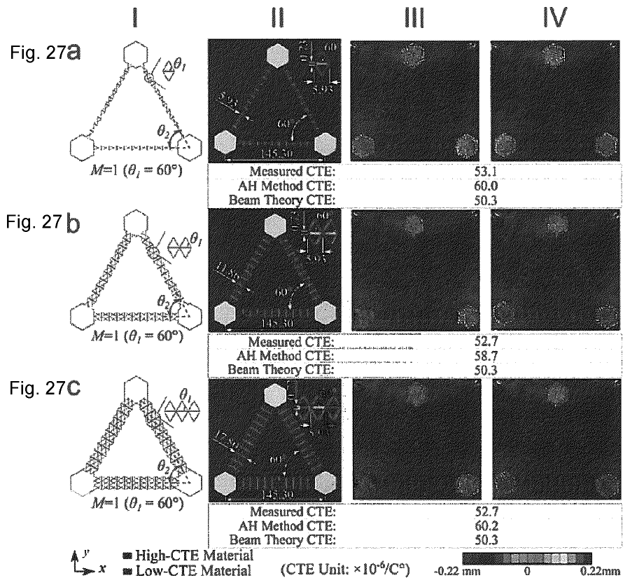

The first set of experiments is illustrated in FIGS. 25a-25 and aims at validating the fractal-like HL 60 (FIG. 3) model that can predict CTE values and its tunability (Eq(A9)), where the low-CTE of a representative lattice is tested in the y-direction. The second set is illustrated in FIGS. 26a-26c and is designed to measure CTE tunability for hybrid-type HL 70 (FIG. 3) with n=2 (Eqs. (A4) and (A13)), and the third set illustrated in FIG. 27a-27c is used to demonstrate thermo-elastic properties decoupling (Eqs. (A4) and (A13)).

In a particular embodiment, sheets of 1.59 mm thickness of each material are used and laser cut to build 2^{nd} order fractal-like 60 and hybrid-type HL 70 (FIG. 3). In a particular embodiment, the laser cutter was calibrated to provide planar deviations within ±0.05 mm. Bar elements 12 and 14 (FIG. 1) were individually embedded to diamond-shaped cells and epoxy glue was applied to provide adherence between materials. Other suitable glue may be used. In a particular embodiment, the epoxy glue thickness was about 0.1 mm, 2% of the typical length of a lattice element; the epoxy CTE (65×10⁻⁶/° C.) was similar to the CTE of acrylic, thus providing negligible influence on the CTE measurements of HL samples. A 3D digital image correlation (DIC) set-up with a temperature controlled heating chamber was assembled and used to assess the CTE of each set of HLs. In total, 3 sets of DIC experiments were undertaken for a total of 9 tests, 3 for each set.

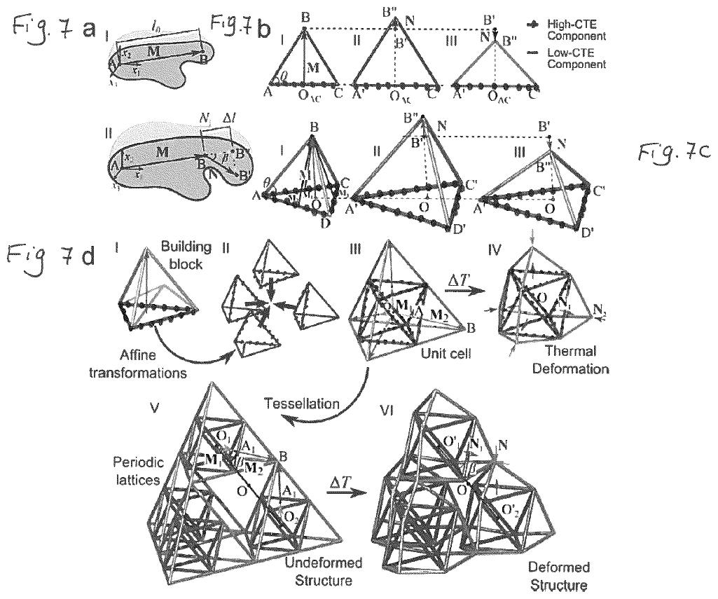

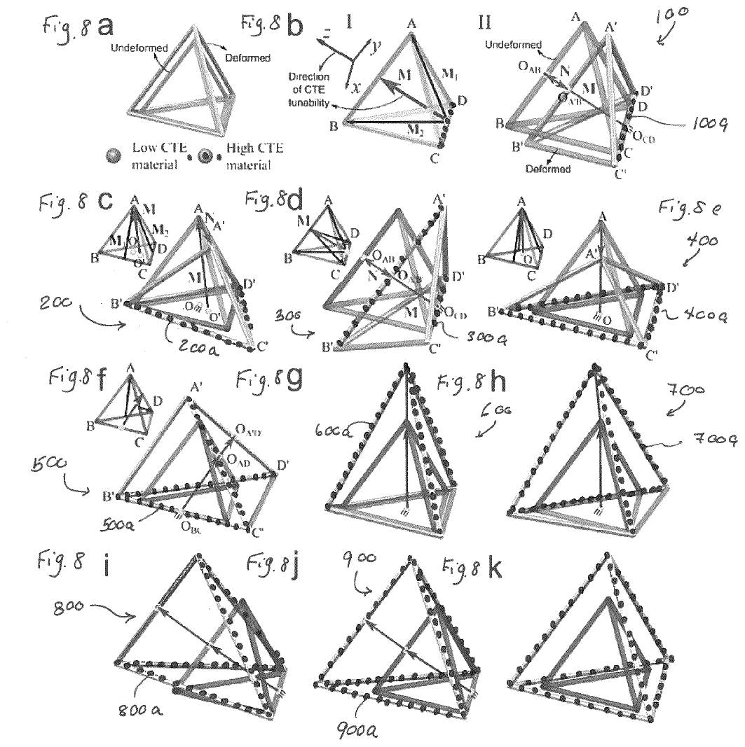

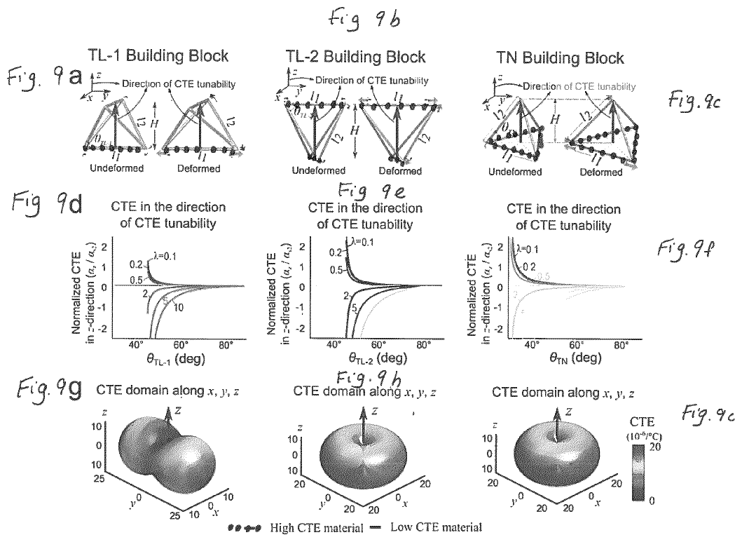

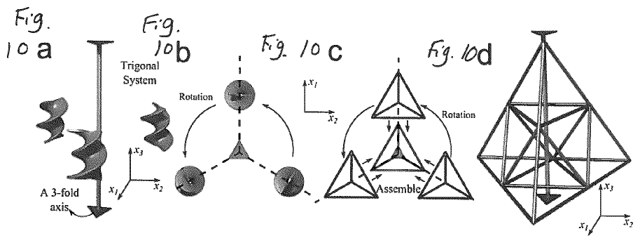

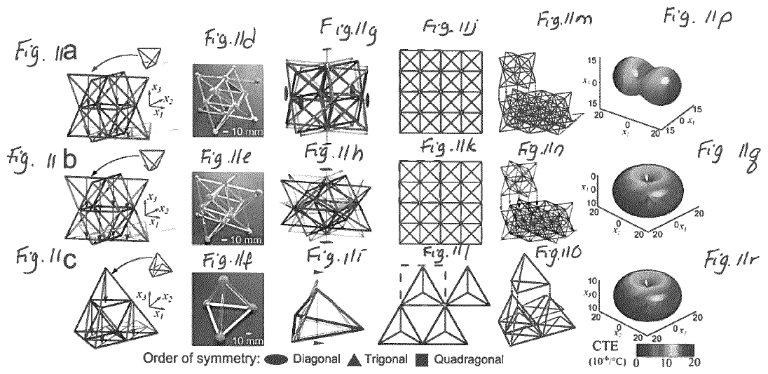

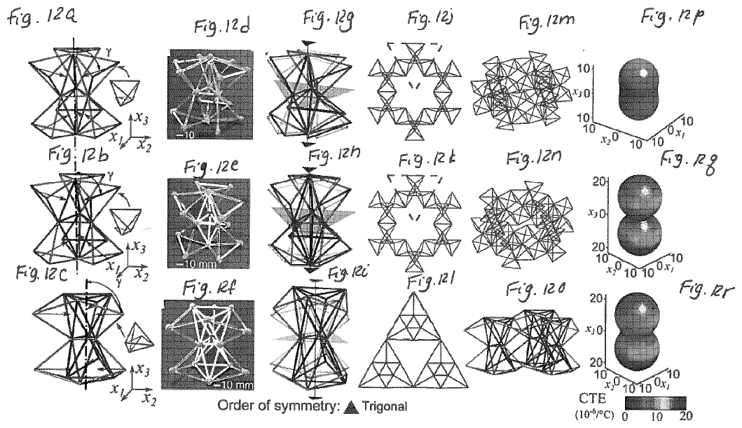

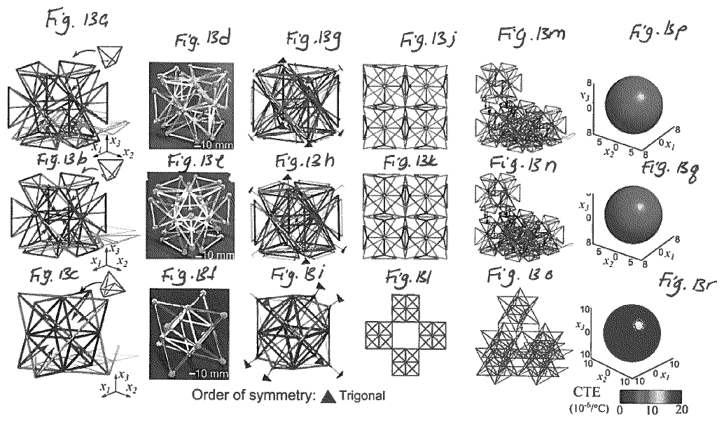

Referring to FIGS. 25a-25c, in the first group, DIC was applied to solid bars of acrylic (FIG. 8a) and 2 fractal-like HLs, one with 1 order of hierarchy (FIG. 25b) and the other with two orders of hierarchy (n=2, FIG. 25c). The skew angle (θ=60°) as well as the wall thickness ratio, which is about t/l=0.1 in the illustrated embodiment, of the fractal-like HL were kept identical. The joints were shaped in hexagons to preserve strut connectivity (six) at each node. To perform DIC, black and white speckles were applied randomly and uniformly across the nodes for thermal displacement measurements. The obtained CTE values along with theoretical and simulated values are summarized along their corresponding columns. Computational values are obtained via asymptotic homogenization.

Now referring to FIGS. 926a-26c, the second set features DIC results for 2^{nd} order hybrid-type HL samples with varying skew angles (55°, 60° and 65°) and hexagonal nodes of dimensions identical to those of the first set (FIG. 25a-25c). To prove CTE tunability of hybrid-type HL for constant Young's modulus, E_{y1}*, the geometry of the three hybrid-type HL (FIGS. 9a to 9c) samples was kept identical with the exception of their skew angles, θ₁, and wall thickness, t₁, in the first order. The computational values are obtained via asymptotic homogenization.

Now referring to FIG. 27a-27c, in the last set of samples, second order hybrid-type HL were built with varying strut thickness to assess the impact of t₂/l₂ on their effective CTE. Here the geometric parameters of all samples were kept identical except the thickness ratio of the second order (n=2) chosen as the only variable. The number of LD along the thickness direction varied from M=1 to M=3 as shown in FIGS. 27a, 27b, and 27c. The computational values are obtained via asymptotic homogenization.

For the test of FIGS. 25a to 27c, testing temperature was monitored and managed from 25° C. to 75° C. through a PID (proportion-integration-differentiation) controller. DIC system calibration ensured an epipolar projection error below 0.01 pixels, i.e. the average error between the position where a target point was found in the image and the theoretical position where the mathematical calibration model located the point. A CCD (charge coupled device) camera was used to focus on an area of 240×200 mm² with a resolution of 2448×2048 pixels; based on the image resolution, any deformation smaller than 0.98 μm (0.01 pixels) was merged by the epipolar projection error. Finally the accuracy of the whole testing system was verified with measures taken from a commercial thermomechanical analyzer.

In the illustrated embodiments, the testing system was calibrated on three solid materials, Al6061, acrylic and PTFE. Table 1 above shows a comparison of their measured and predicted mean CTE along with their standard deviations, with errors below 3%. The epipolar projection error is at 0.98 μm, which governs the smallest measured CTE value of the samples, i.e. 0.27×10-6/° C. The low magnitude of these errors warrants the required accuracy for the DIC system used in this work.

FIGS. 25a-III and IV show thermal deformation maps for the solid material, acrylic, in both x- and y-directions, respectively. The tested CTE is observed isotropically in all directions in the 2D plane. While their thermal deformation is shown in FIG. 25a to FIG. 27a-III and IV in both x- and y-directions, mean CTE from testing are summarized in Table 2 below, along with their standard deviation and CTE predictions. The error associated with testing results only go as high as 5%, and the difference between tests and the computational values obtained via asymptotic homogenization (AH) are generally within 10% error, with the exception of fractal-like HL (n=2) sample, where the amplified low-CTE behaviour also amplifies the deviation between both results.

TABLE 2
Predicted and experimentally measured CTE values for
fractal-like and hybrid-type HL (σₓ and σ_{y} indicate standard deviation).

| | Predicted CTE | | Measured CTE | | | |
|---|---|---|---|---|---|---|
| | (Beam Theory, ×10⁻⁶/° C.) | | (×10⁻⁶/° C.) | | Error | |
| Sample | x | y | x [symbol] σₓ | y [symbol] σ_{y} | x | y |
| Fractal-like HL (n = 1) | 115.0 | 62.0 | 115.2 [symbol] 0.3 | 60.3 [symbol] 2.4 | 0.2% | 2.8% |
| Fractal-like HL (n = 2) | 138.7 | 20.8 | 125.5 [symbol] 1.3 | 29.2 [symbol] 0.9 | 10.5% | 28.8% |

| | | | |
|---|---|---|---|
| Hybrid-type HL (55°, M = 2) | 43.4 | 49.6 [symbol] 1.3 | 12.5% |
| Hybrid-type HL (60°, M = 2) | 49.4 | 52.1 [symbol] 0.6 | 5.2% |
| Hybrid-type HL (65°, M = 2) | 55.0 | 56.4 [symbol] 2.9 | 2.5% |
| Hybrid-type HL (60°, M = 1) | 50.3 | 53.1 [symbol] 1.3 | 5.3% |
| Hybrid-type HL (60°, M = 2) | 50.3 | 52.7 [symbol] 1.6 | 4.2% |
| Hybrid-type HL (60°, M = 3) | 50.3 | 52.7 [symbol] 1.6 | 4.2% |

[symbol]

indicates data missing or illegible when filed

FIG. 25b-IV illustrates that LD (FIG. 25b-I, n=1 with θ=60°) without structural hierarchy can reduce the CTE along the y-direction from 67.0×10⁻⁶/° C. (n=0, i.e. the component material, acrylic, as shown in FIG. 25a-I) to 60.3×10⁻⁶/° C. However, for increasing hierarchical order, fractal-like HL (FIG. 25c-I, n=2) can further reduce the effective CTE in the y-direction to 29.2×10⁻⁶/° C., result obtained with no change in material selection nor skew angle. By adding hierarchical orders from n=1 to n=2, fractal-like HL shows a CTE tunability up to 31.1×10⁻⁶/° C.

FIG. 26-III and IV show for hybrid-type HL the decrease of the effective CTE from 56.4×10⁻⁶/° C. (θ₁=65° to 49.6×10⁻⁶/° C. (θ₁=55°, which emphasizes a much smaller CTE tunability (6.8×10⁻⁶/° C.) in comparison with adding hierarchical orders (31.1×10⁻⁶/° C.). The combination of varying skew angles and adding hierarchical orders appears to be proficient in tuning the effective CTE. For the last set of specimens, however, the effective stiffness relative to an hybrid-type HL with M=1 is expected to double for M=2 and triple for M=3; the overall effective CTE displays a tendency of remaining substantially constant around 53×10⁻⁶/° C. These results experimentally show that thermo-elastic properties can be decoupled in hybrid-type HL, as explained in more detail below.

Referring now back to FIGS. 4a-4d, which illustrate the CTE values for low- and high-CTE fractal-like HL 60 (FIG. 3) in the y-direction as a function of hierarchical order. Each of the plotted lines, obtained from Eq. (A9), represents CTE values for a given skew angle, θ, and starts from n=0, solid materials, through n=1, the HD and LD, followed by fractal-like HLs with increasing hierarchical order n≥2. We recall that these predictions represent discrete values of CTE, each obtained for a given n, although the trends are shown as continuous to ease their interpretation within each figure. Assuming the CTE of PTFE and acrylic as the high and low CTE values, respectively, we observe that as the order increases from 0 to 1, the effective CTE of HD is higher than that of PTFE, whereas the CTE of the LD is lower than that of acrylic. The gap between these two CTE spectra, i.e. LD and HD, taking θ=60° as an example, enlarges from 56×10⁻⁶/° C. (initial gap between solid materials) to 93×10⁻⁶/° C., meaning an increase of 165% in ΔCTE. As the order changes from 1 to 2, the gap increases even more drastically to 154.7×10⁻⁶/° C. (275% of the initial gap) and larger once more from order 2 to 3, reaching 257.3×10⁻⁶/° C. (460% of the initial gap). CTE tunability (ΔCTS) increases with the order of hierarchy, so as to theoretically approach an unbounded value for unlimited n.

We also note the shaded region in FIG. 4a, where the lattice collapses to a by-layer laminate. This concept can cover CTE values between the CTEs of the constituent solids by changing their layer thickness ratio. Furthermore, FIG. 4b illustrates structural efficiency—a metric expressed here as the ratio of the specific stiffness of the lattice to that of the solid materials—in the y-direction of low- and high-CTE fractal-like HL versus hierarchical order. For normalization purposes, solid acrylic (blue in figure) is considered as benchmark with 100% structural efficiency. With the increase of hierarchical order, the structural efficiency of fractal-like HL decreases. This is expected as stretch dominated lattices become more compliant with higher order of hierarchy. FIGS. 4a and 4b show that the thermo-elastic properties of fractal-like HL are coupled, and CTE changes as structural efficiency does.

FIGS. 4c, 4d show the predicted CTE and structural efficiency for hybrid-type HL 70 (FIG. 3) as a function of the hierarchical order and the skew angle, θ₁, in the range 50°-70°, which is representatively chosen here to visualize the effect of varying skewness. In FIG. 11c, the first order (n=1) allows some degree of CTE tailoring with a gap increase between the low and high CTE spectra from 56×10⁻⁶/° C. to 93×10⁻⁶/° C. With the addition of the second order (n=2), this time hybrid-type HL, as opposed to fractal-like HL, allows stiffness modulation without thermal expansion variation. Hence CTE substantially remains insensitive, i.e. ΔCTE between the first two orders is constant, despite a drop of structural efficiency.

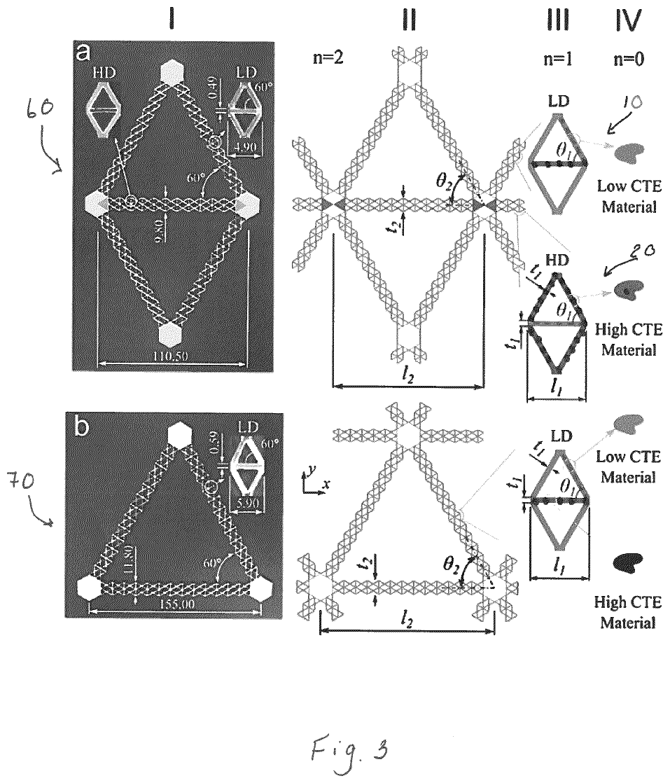

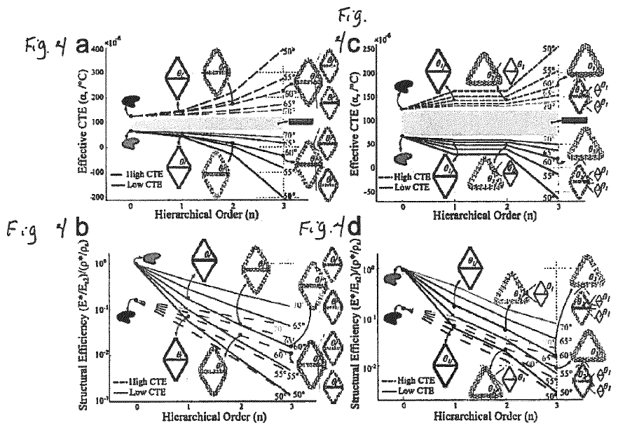

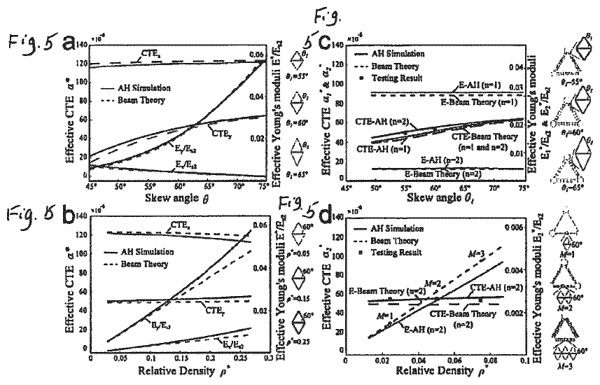

The trends shown in FIGS. 4c and 4d between n=1 and n=2 are now used as example to show how hybrid-type HL can be effective in decoupling thermal and mechanical properties. To do so, we first show that CTE and Young's modulus for LD are inherently coupled and hence no independent tuning is possible. This is shown in FIGS. 5a, 5b where Eqs. (A1) to (A5) are plotted in dash style along with results obtained from AH (continuous style), here included to provide a further element of validation to the analytic models presented therein.

FIG. 5a shows that for prescribed t₁/l₁, a reduction of the skew angle brings a decrease of both the CTE and Young's modulus in the y-direction. On the other hand, if the skew angle is given and t₁/l₁ varies (FIG. 5b), both the CTE and Young's modulus in the y-direction show a monotonic increase for rising relative density. Hence FIG. 5a, 5b visualise the thermo-elastic coupling that exists in diamond lattices.

FIG. 5c, d show results for CTE and Young's modulus obtained from Eqs. (A12) and (A13) for hybrid-type HL of two orders (FIG. 3b-I). Also in this case, results from closed-form expressions are reported along with those obtained computationally via AH. FIG. 5c shows that a changed θ₁ in the first order of hybrid-type HL enables CTE tuning for both orders, while causing no impact in the Young's modulus, as shown by its unchanging trend. Likewise in the mechanical spectrum, FIG. 5d shows that the effective Young's modulus can be varied with relative density with no effect on the CTE. It is the thickness ratio of the second order, t₂/l₂, that, in this case, is the variable empowering the Young's modulus modulation for inviolate values of CTE. FIGS. 5a-5d, thus, give a visual summary of model predictions validated through experiments for thermo-elastic coupling, which appears to have been bypassed with hybrid-type HL. This is achieved in (c) through changing both the skew angle of the first order, θ₁, and t₁/l₁, and in (d) by keeping these parameters constant and varying the relative density of the second order, ρ₂*/ρₛ*.

Experimental results with specifics illustrated in FIGS. 25a to 27c, are reported in FIGS. 5a, 5c and 5d and provide validation to the trends obtained via closed-form expressions presented above. Thermo-elastic properties of fractal-like HL in FIGS. 4a-4d demonstrate that the addition of only one order of hierarchy enlarges the CTE tunability by 66%, which is up to five times higher than what can be obtained through a change in skew angle. On the other hand, hybrid-type HL allows an increase in structural efficiency equal to 0.0585 of 20.6% (FIG. 11 at n=2) with respect to that of fractal-like HL (0.0485) at the identical order. Validated models of hybrid-type HL suggest that concepts with higher orders can offer much larger CTE tunability than stretch-dominated lattice benchmarks and superior mechanical performance than baseline concepts that are bend-dominated, in addition to their decoupled, planar isotropic thermo-elastic properties.

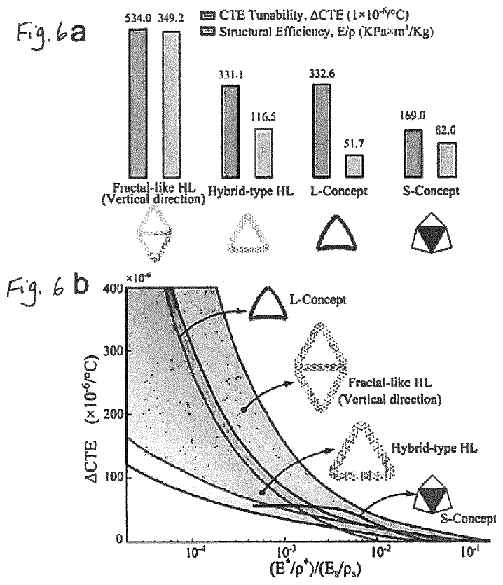

To compare the thermo-elastic performance of fractal-like and hybrid-type HL (n≤5) with the existing ones, in particular L-Concept and S-Concept, we plot in FIG. 6a bars of their specific stiffness, a measure of structural efficiency, and of ΔCTE, the CTE tunability defined as the maximum range of CTE values a concept can offer. The magnitude of a given performance metric is represented by the bar height. All concepts are compared on an equal basis, as they are generated from the same pair of materials (PTFE and acrylic). With respect to the left-hand side bars of CTE tunability in FIG. 6a, ΔCTE is calculated for each concept and for a given value of Young's modulus, which is representatively considered here as 1 MPa. From the bar rises, we gather that fractal-like HL dominates with the largest CTE range (534×10⁻⁶/° C.), whereas ΔCTE for the S-Concept is the smallest (169×10⁻⁶/° C.). ΔCTE for hybrid-type HL (331.1×10⁻⁶/° C.) is as high as that of L-Concept (332.6×10⁻⁶/° C.), which is claimed to provide unbounded ΔCTE. This is quite unique, as the L-Concept relies on bend-dominated cells, whereas the proposed hybrid-type HL can obtain a similar result using a much stiffer structure. Similarly with respect to structural efficiency (right-hand side bars), FIG. 6a provides a visual comparison of the specific stiffness of each concept for a representative CTE value that is here assumed as half the average of the materials' CTE (47.5×10⁻⁶/° C.). From the bars, we observe that fractal-like HL has the highest specific stiffness in the y-direction (349.2 KPa×m³/Kg) followed by hybrid-type HL (116.5 KPa×m³/Kg), both of which outperform the existing concepts. More specifically, focusing on planar isotropic materials, hybrid-type HL provides a 42% increase in structural efficiency compared to the stiff, yet dense, S-Concept (82 KPa×m³/Kg), while demonstrating twice the specific stiffness of the L-Concept (51.7 KPa×m³/Kg).

A more comprehensive comparison of the concepts is illustrated in FIG. 6b, where CTE tunability is plotted versus specific stiffness. The curves are created from a parametric study of the unit cells, where the skewness angle and the thickness-to-length ratio are the active variables for given materials. Hybrid-type and fractal-like HL are compared with L-Concept and S-Concept, the benchmarks. While both high- and low-CTE cases (FIG. 11) can be plotted, FIG. 6b displays only the low-CTE concepts which are sufficient to capture the potential of hierarchical lattices. We recall that, in this low-CTE case, ΔCTE is defined by the range between the lowest CTE value of a given low-CTE concept, at the calculated structural efficiency, and the CTE of the solid material with lower thermal expansion (i.e. 67×10-6/° C. of acrylic). As can be seen, in these examples, a ratio of the first (high) CTE to the second (low) CTE may be between 0.1 and 10, and wherein a range of CTE (ΔCTE), defined between a lowest CTE value of the lattice structure and a CTE of a solid material having lower thermal expansion, is between 100×10-6/° C. and 550×10-6/° C.

While S- and L-Concepts show curves that describe the change of ΔCTE with structural efficiency, hybrid-type and fractal-like HL are represented by two domains. These shaded regions represent the possible set of curves that are obtained with varying hierarchical orders. For both cases, the first hierarchical order that makes up the concept (n=1 for fractal-like HL and n=2 for hybrid-type HL) provides the most optimal curve (closest to the top-right corner). The following hierarchical orders (the second for fractal-like HL, and the third for hybrid-type HL) provide the least optimal curve, while higher orders lie in between. Higher hierarchical orders are predicted to approach the curve of the first order (n=1 for fractal-like HL and n=2 for hybrid-type HL) with increasing n.

In general, FIG. 6b shows a Pareto-front for the existing concepts, thus showing trade-offs between metrics: an attempt of increasing structural efficiency results in a reduced ΔCTE. This trade-off is not only influenced by the relation between geometric parameters and effective properties, but also by the design requirements. For example, the L-Concept is the ideal candidate to attain large CTE tunability, whereas the S-Concept is ideal for structural efficiency, as both are designed for different specifications. When considering the concepts presented in this paper, a better overall performance can be observed compared to the existing baselines. The curves derived from both fractal-like and hybrid-type HL are offsets of the L- and S-Concept toward the top right corner on the figure, where both high CTE tunability and high structural efficiency are achieved; hence their domains show higher potential of hierarchical lattices to attain better trade-offs between ΔCTE and E/ρ.

In FIGS. 6a-6b, results are obtained from a parametric study of unit cell geometry, where the list of possible sets of properties for each concept are sorted by increasing structural efficiency, and then grouped based on a range of similar values of the Young's moduli over density ratio. The minimum CTE value is selected from each group to calculate Δ_{CTE} for a given ratio E/ρ. This value, the median structural efficiency of each group, is plotted as a point on the graph with the corresponding ΔCTE value on the ordinate axis.

Referring now to FIG. 7a that shows a two-dimensional triangle made of three pivotably (i.e. hingedly) connected rods. As shown, a material length vector M and a thermal displacement vector N are shown. The direction of the material length vector M defines a referential direction along which the thermal expansion is measured, and whose magnitude describes the distance between two points on the triangle. If point one of the two points is selected as a stationary reference, with a change in temperature (ΔT), the other of the two points can move away from its original location to reach a generic point B′ (FIG. 7c), thereby creating the vector, N, which is defined as the thermal displacement vector. The vector N extends from the original position of the other of the two points to its final position.

Assuming there is no rigid-body translation or rotation of the CTE in the direction of M, α_{M}, can be expressed as:

$${α}_{M} = \frac{M \cdot N}{{M}^{2} Δ T} , \qquad ( B4 )$$

where “·” represents the dot product and ΔT is a scalar representing the temperature variation. Hence, for a unit change in temperature the CTE in any arbitrary direction is the thermal extension or contraction, per unit length of a line drawn originally in that direction. The simple concepts for ML and TD vectors described above for a solid material (FIG. 7a), can be extended to a dual-material triangle truss in 2D (FIG. 7b) and further to a tetrahedron truss in 3D (FIG. 7c). With a temperature increase, the height rise of the dual-material triangle in FIG. 7b, triggered by the blue elements with low CTE is compensated by the sinking of its top vertex (Point B) due to the higher thermal expansion of the red bar with high CTE. In FIG. 7b-I, the ML vector describes the direction of thermal expansion between the midpoint of the base (O_{AC}, taken here as the reference point) and the apex (point B), which is the only CTE tunable direction in the triangle. By harnessing the CTE values of the solid components, αₛ₁ and αₛ₂, or the skewness of the blue elements, θ, we can tailor the CTE of the dual-material triangle in the vertical direction, so as to assume one of the following value: positive (FIG. 7b-II) with codirectional ML and TD vectors; negative (FIG. 7b-III) with ML and TD vectors in the opposite direction; or zero with a zero TD vector.

Similarly in 3D, the M vector of the dual-material tetrahedron (FIG. 7c-I,) is defined by the apex (point B) and the centroid of the base triangle (point O, taken as the reference point). With a temperature increase, the height rise, i.e. the thermal expansion in the M direction, triggered by the blue elements is counteracted by the sinking of its apex due to the higher thermal expansion of the red base (ΔACD). In this case, all lateral faces (i.e. ΔBAC, ΔBAD, and ΔBCD) of the dual-material tetrahedron are low-CTE triangles (FIG. 7b-I), and the resultant of all three ML vectors of the low-CTE triangles (i.e. M₁, M₂, and M₃ in FIG. 7c-I) passes through points O and B. Thus, the direction of the resultant vector given by the sum of M₁, M₂ and M₃ (each representing the only CTE tunable direction in 2D) is equidirectional to the M vector of the tetrahedron (green vector in FIG. 7c-I, representing the only CTE tunable direction in 3D). This observation highlights a directional relationship of CTE between a tetrahedron and its triangular faces: the resultant of the 2D ML vectors of the triangles specifies the CTE tunable direction of the tetrahedron, chosen here as the direction of the 3D ML vector. In other words, the direction of the tunable thermal expansion in the triangular faces governs that of the overall tetrahedron. This rule is also useful for locating the ML vector direction of other types of dual-material tetrahedra, along with the CTE tunable directions, as explained in the following section. As per the magnitude, the effective CTE in 3D, similar to the 2D case, can be tailored to be positive (FIG. 7c-II), negative (FIG. 7c-III), and zero through a change in θ and/or αₛ₁/αₛ₂. In both 2D and 3D cases, the apex point B can be termed as stationary node, since for the zero-CTE case its position relative to the reference point can remain stationary during thermal expansion.

The ML and TD vectors can also express the CTE of an assembly of building blocks, such as the unit cell shown in FIG. 7d-III Here in this exemplifying case, simple affine transformations, in particular translation and rotation (FIG. 7d-II), are used to assemble the dual-material building block (FIG. 7d-1) into a unit cell with multiple subunits (FIG. 7d-II). The assembly of the four tetrahedra in FIG. 7d-II creates a high CTE octahedron core within the unit cell (FIG. 7d-III). The ML vectors, M₁ in orange for the octahedron core, and M₂ in green for the tetrahedron (FIG. 7d-III), can be defined between the center of the unit cell, point O, taken as the reference point, and the vertex B, separated by point A (FIG. 7d-III). The overall thermal expansion behavior between O and B is given by the sum of the corresponding vectors, M₁, M₂, and the TD vectors, N₁ and N₂, of these two thermally distinct parts, OA and AB. Hence the thermal expansion of the assembled unit cell in FIG. 7d-III can be simply expressed as:

$${α}_{M} = \frac{{\sum }_{k} ( {M}_{k} {gN}_{k} \text{/} {M}_{k} )}{Δ T {\sum }_{k} {M}_{k}} ( k = 1 , 2 ) . \qquad ( B6 )$$

We now show that the above ML and TD vectors can also be applied to desired 3D tessellations of compound units. FIG. 7d-V shows an example with a periodic truss assembled with the compound cell of FIG. 7d-III. The distance between the centers of any adjacent unit cells, such as between centers O₁ and O₂, can be accessed via ML and TD vectors, as shown in FIG. 7d-V and VI. In this case, the thermal expansion of the spatial truss can be simply expressed as:

$${α}_{{O}_{1} {O}_{2}} = \frac{{\sum }_{k} {N}_{Pk}}{Δ T {\sum }_{k} {M}_{Pk}} ( k = 1 , 2 ) , \qquad ( B7 )$$

where N_{Fk} and M_{Fk} are the components of Nₖ and Mₖ parallel to O₁O₂, respectively. We remark here that since the projection cosine of both N_{Fk} and M_{Fk}, i.e. cos β, is identical, the terms containing the directional angle, β in FIG. 7d-V and VI, cancel out in both the numerator and denominator of Eq. (7). No matter which direction is considered, the CTE for this cell topology is identical in all directions, thus equaling the effective CTE evaluated by Eq. (6), i.e. α_{O}_{₁}_{O}_{₂}=α_{M}. We can conclude that since the thermal expansions between centers of any adjacent unit cells are identical, the overall CTE of the truss material shown in FIG. 7d-V is thermally isotropic and the magnitude can be evaluated by the vector analysis explained above.

The concept presented in FIGS. 7c and d are given as examples to show the handiness of using vectors to visualize and analyze thermal expansion of a periodic truss built from single units as well as a more complex assembly of compound units. In both cases, the primitive building block is a tetrahedron that features a distinct arrangement of solids in its bars. But this is just one among many other material layouts that are feasible. The following sections examine all the possible material arrangements that can appear in the strut of a dual-material tetrahedron, each defining a building block with its own specific CTE profile.

2.2. Exploration of Dual-Material Tetrahedra

The simplest 3D hinged structure that is free to deform upon temperature changes is a tetrahedron. Six types of rods can make up its frame, and different combinations of component materials or dimensions are possible. Below we examine all the material permutations that can occur in the struts of a dual-material tetrahedron, and study the relation that each of these has with the CTE along its principal axes. The goal here is to provide a foundational basis to understand other, more complicated, truss-like materials.

2.2.1 Thermal Deformation Mode of Dual-Material Tetrahedra

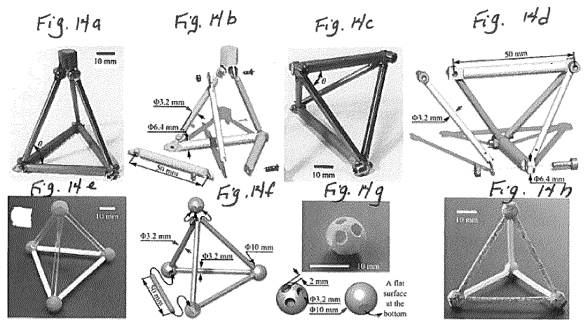

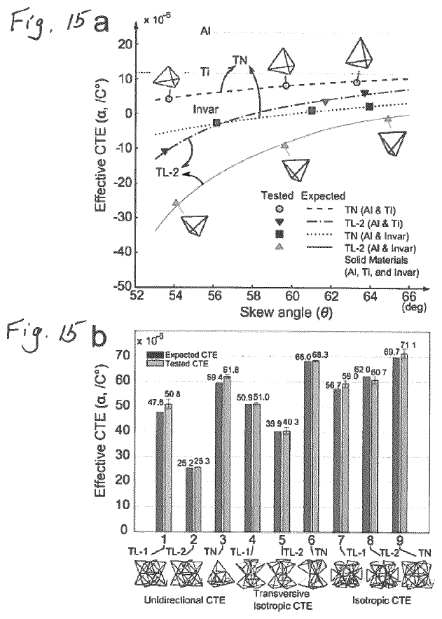

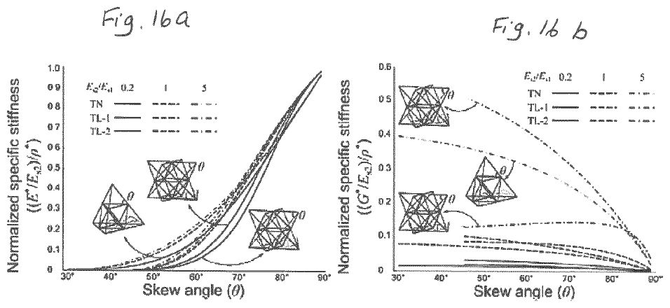

Let us consider a tetrahedron made of six rods, each made of a material with either low or high CTE, but both positive. FIGS. 13a-13r show all the possible material permutations that can appear by simply switching the position of rods with high-CTE rods shown in dashed line, αₛ₁, and low-CTE rods shown in solid lines, αₛ₂. In total, there are eleven possible arrangements, each visualized by a tetrahedron from FIG. 8a to k. For monomaterial tetrahedra (e.g. FIGS. 13a and 13k), the thermal expansion is uniform; as there is no thermal mismatch, no opportunity exists to tailor the CTE. For the remaining tetrahedra, on the other hand, CTE tunability is possible as the effective CTE can be adjusted in one or more directions. It is possible to split the nine tetrahedra into three groups:
Low-CTE tetrahedra 100, 200, 300, 400 (FIGS. 13b to 13e), which can yield an effective CTE that is lower than the CTEs of both the component materials; the high-CTE bars being shown in dashed line and referred to as 100a, 200a, 300a, 400a;
Intermediate-CTE tetrahedron 500 (FIG. 13f), the only one able to attain the effective CTE of a value between the CTEs of the two components only; the high-CTE bars being shown in dashed line and referred to as 500a;
High-CTE tetrahedra 600, 700, 800, 900 (FIGS. 13g to 13j), with effective CTEs higher than both the CTEs of the components; the high-CTE bars being shown in dashed line and referred to as 600a, 700a, 800a, 900a.

For a tetrahedron, the direction of the 3D ML vector with CTE tunability is controlled by the resultant of the 2D ML vectors of its triangular faces, and can be purposely chosen to align along one of the principal axes of a tetrahedron. As explained in later sections, this choice eases the assembly of building blocks in spatial lattices and helps identify the direction of CTE tunability.

FIG. 13b shows a tetrahedron in which one of the rods possesses high-CTE as opposed to the rest with low-CTE and hence defines two low-CTE triangles whose resultant sets the direction of the for this tetrahedron. The tetrahedron of FIG. 13b has one line YY that is stationary with respect to the rod YY that is made of the high-CTE material. The tetrahedron of FIG. 13b is hence referred to as a tetrahedron with stationary lines (TL-1) and its effective CTE is expressed as:

For the zero-CTE case, points A and B are stationary nodes with respect to the line CD in the low-CTE triangles. Analogously, the relative position, including the minimum distance and skew angle between the two skewed lines, AB and CD, can be constant under a temperature change. We can thus name the pair of lines AB and CD as stationary lines (SL), and call the tetrahedron shown in 13b as a tetrahedron with stationary lines (TL-1). Under the pin-jointed assumption, through Eq. (4) we can obtain its effective CTEs as:

$$\{ \begin{matrix}{α}_{x} = {α}_{s 1} \\ {α}_{y} = {α}_{s 2} \\ {α}_{z , TL - 1} = \frac{{α}_{s 2} - ( {α}_{s 1} + {α}_{s 2} ) {cos}^{2} {θ}_{TL - 1}}{1 - 2 {cos}^{2} {θ}_{TL - 1}}\end{matrix} , {θ}_{TL - 1} ∈ ( 45 ° , 90 ° ) . \qquad ( B8 )$$

Where, in this case, the ML vector is aligned with the axis Z.

FIGS. 13c and 13d show two other possible ways by which the positions of high- and low-CTE bars can be permuted. Here two high-CTE bars (shown in dashed lines) and four low-CTE bars (shown in solid lines) make up the tetrahedra: the high-CTE bars of the former meet at one of their vertices, while the high-CTE bars of the latter are not in contact. In this case, after thermal expansion, the tetrahedron is no longer a regular triangular pyramid. In FIG. 8d, all four triangles of the tetrahedron have a low CTE bar. The tetrahedron in FIG. 8d has a pair of stationary lines that can be used for CTE tailoring. The effective CTEs of this tetrahedron with stationary lines (TL-2) is defined as:

$$\{ \begin{matrix}{α}_{x} = {α}_{y} = {α}_{s 1} \\ {α}_{z , TL - 2} = \frac{{α}_{s 2} - 2 {α}_{s 1} {cos}^{2} {θ}_{TL - 2}}{1 - 2 {cos}^{2} {θ}_{TL - 2}}\end{matrix} , {θ}_{TL - 2} ∈ ( 45 ° , 90 ° ) . \qquad ( B9 )$$

For a tetrahedron with three high-CTE bars and three low-CTE bars, there are three possible ways by which bars can be arranged (FIGS. 13e, 13f, and 13g). In the arrangement shown in FIG. 13e, the high-CTE bars are connected in a loop. In these cases, the apex of the tetrahedra is a stationary node. The effective CTEs of the tetrahedron of FIG. 13e is expressed as:

$$\{ \begin{matrix}{α}_{x} = {α}_{y} = {α}_{s 1} \\ {α}_{z , TN} = \frac{3 {α}_{s 2} - 4 {α}_{s 1} {cos}^{2} {θ}_{TN}}{3 - 4 {cos}^{2} {θ}_{TN}}\end{matrix} , {θ}_{TN} ∈ ( 30 ° , 90 ° ) . \qquad ( B10 )$$

The effective CTE of the other tetrahedra may be similarly determined. The CTE of the regular tetrahedra presented above can be adjusted by manipulating both material of its constituents rods and geometric variables, in given directions. Herein, the role of these two CTE-dependent variables on the effective CTE of building blocks for both high- and low-CTE concepts are examined. Three CTE-tunable building blocks with different linear-dominant thermal deformation modes along the principal direction: TL-1 (FIG. 13b), TL-2 (FIG. 13d), and TN (FIG. 13e). The zero-CTE cases of these building blocks are also visualized in FIGS. 13a, 13b, and 13c before and after thermal expansion; each tetrahedron is orientated to keep the ML vector along the vertical direction, demonstrating the concepts of stationary line and stationary node.

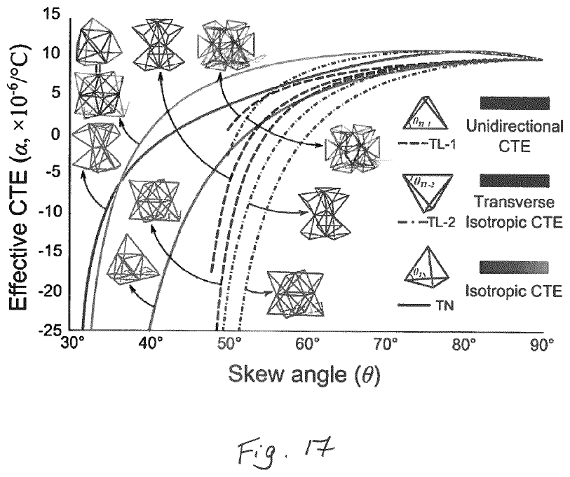

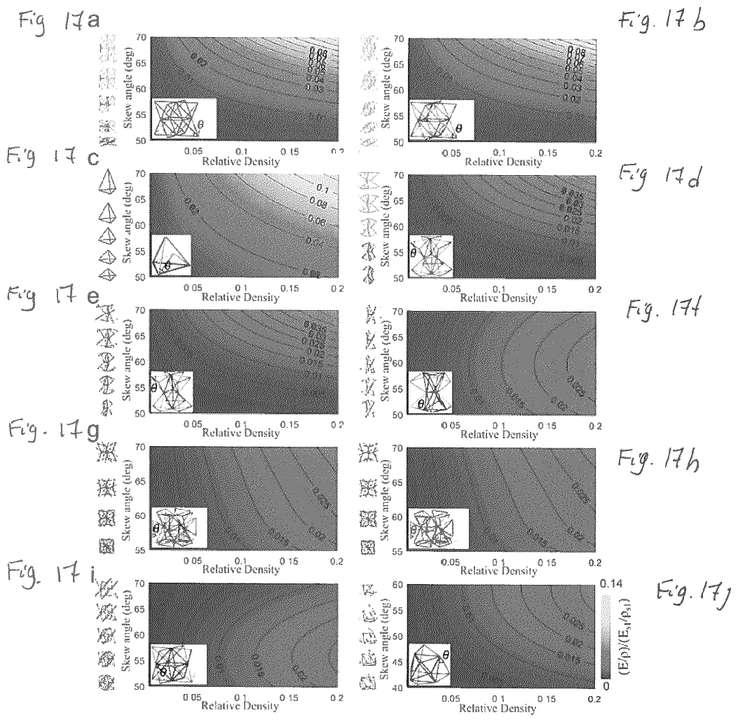

Referring now to FIGS. 14d, 14e, and 14f, the effective CTEs of both low- and high-CTE tetrahedra along the z-direction against the skew angles are plotted. In the case, the z-direction, is the only CTE tunable principle direction while along the others the CTE is that of the constituent solids. As depicted in FIGS. 14d, 14e, and 14f, the effective CTE, α₂, of the building blocks can be tuned by changing the skew angles to cover a large range of values, from large negative/positive to approximately zero, demonstrating a sizeable CTE tunability. FIG. 14d to f also demonstrate that the CTE in the z-direction depends on the CTE ratio of the constituent materials, λ=αₛ₁/αₛ₂. If the skew angle, θ, is given, the larger/smaller the λ, the lower (for low CTE concept, FIG. 8b, d, and e) or higher (for high CTE concept, FIGS. 13g, 13i, and 13j) the effective CTE, respectively. Hence the greater the CTE distinction of the constituent solids, the higher the CTE tunability. The aforementioned building blocks distinguished by their own tunable characteristics lay the foundation for designing stiff and strong spatial lattices with tunable CTE, as shown below.

It is possible to construct lattices using the building blocks, TL-1, TL-2, or TN, along with their ML vectors aligned in the CTE tunable direction to program thermal expansion in spatial lattices with high specific stiffness and strength. Notions of crystal symmetry, in particular from the crystallographic point groups, are applied to the building blocks and used to assemble more complex truss systems that can meet desired CTE requirements. Nine examples of lattices are engineered to attain unidirectional, transverse isotropic, or isotropic controllable CTE. In a general case, the thermal expansion requirements a system should attain can be specified by: (i) the magnitude and sign of its CTE, which can be large positive, near zero, or negative, and/or (ii) the thermal expansion directionality, defining its anisotropic or isotropic behaviour. The former is a requirement mainly governed by the geometry and components of the building blocks. The latter correlates with the directions of the CTE properties that are governed by the assembly rules of tetrahedral building blocks, such as orientation, symmetry operations, and relative position, as explained below.

There is theoretically an infinite number of unit cells that can be proposed to meet the unidirectional requirement of CTE. FIGS. 15a, 15b, and 15c show three of them, each constructed with its own building block and a specific relation of symmetry, but all have unidirectional CTE tunability in the vertical direction (x₃).

The first unit cell in FIG. 11a consists of eight TL-1 building blocks assembled via reflection and rotational transformations to make each adjacent block appear in an upside-down position. In this unit cell, there are only three mutually perpendicular 2-fold axes with an inversion center but no axes of higher order, e.g. 3-fold or 4-fold axes; hence, the unit cell has an orthorhombic symmetry (FIG. 11g). All ML vectors of TL-1s in FIG. 11a are parallel with the vertical direction and therefore the CTE-tunable mechanism of TL-1 governs the thermal deformation of the unit cell in the vertical direction. The CTE tensor of an orthorhombic unit cell has three independent components with values equivalent to the principal CTEs. Although the overall CTE is orthotropic, the entire lattice shows unidirectional CTE tunability with magnitude of α₃=α_{z,TL-1} (Eq. (B8)) that is tunable in the vertical direction only. Along the other two principal directions α₁=αₛ₁ and α₂=αₛ₂, the periodic lattice can uniformly expand with the CTE of its components. The second unit cell shown in FIG. 11b is structured with eight TL-2 building blocks via only rotation around, and translation along, the vertical direction. This unit cell has a 4-fold axis with a middle mirror plan, and thus classed as tetragonal symmetry. In its CTE tensor (Tab. 1), there are only two independent coefficients: α₁=αₛ₁ and α₃=α_{z,TL-2} (Eq. (B9)). This unit cell, although obtained with symmetry relationship different from that of the previous model, still keeps all ML vectors of the building blocks along the vertical direction and therefore results in a unidirectional CTE controllable in the vertical direction. The unit cell in FIG. 11c uses the TN tetrahedron, which has a trigonal symmetry (FIG. 10b and FIG. 11i). As discussed above, the only two independent coefficients are α₁=αₛ₁ and α₃=α_{z,TN} (Eq. (B10)), thereby demonstrating unidirectional CTE tunability.

The three concepts in FIGS. 11a-11r feature dissimilar symmetry systems constructed via different affine transformations, however, they all keep the M vectors in the CTE tunable direction along direction x₃. The direction x₃ of each concept follows the direction of the 2-fold, 3-fold, and 4-fold axes, which are principal directions. Each unit cell, therefore, inherits the CTE tunability of its building block in the principal direction x₃. FIGS. 11p, q, and r illustrate their omnidirectional CTEs in a spherical coordinate system, from which a pertinent symmetry in thermal expansion appears for each case. The direction with the lowest CTE (dark blue in the legend), i.e. a single vertical axis for each unidirectional concept, is the principal direction of CTE tunability. No CTE tunability is viable along the other principal directions, i.e. plane x₁-x₂.

2.3.2 Transverse Isotropic CTE Requirement

FIGS. 12a, 12b, and 12c show three unit cells, each assembled with its own building block but all have trigonal symmetry to meet transverse isotropic CTE requirement. In the first example (FIG. 12a), low-CTE stationary lines of six TL-1s form the inner core with two sets of triadic building blocks at the same altitude (x₃) arranged with equal angular spacing. On the middle mirror plane (FIG. 12g), three additional low-CTE bars are added, combined with the six low-CTE stationary lines, forming a central triangular bipyramid. This operation, considered along with the periodic tessellation in FIG. 12m, is enforced to lock any mechanism as well as to make the unit able to perform as a pin-jointed structure. As shown in FIG. 12g, the unit cell consists of 3-fold rotational symmetry, analogous to the trigonal crystal, it has only two independent components in the CTE tensor, α₁ and α₃. All TL-1 ML vectors deviate outward from the vertical direction by an identical deviation angle, γ (γ∈(0°, 90°) with γ=75° in FIG. 12a), which, together with the skew angle and component CTEs, controls the horizontal effective CTE with in-plane isotropic CTE tunability (α₁=α₂). In the out-of-plane principal direction, i.e. x₃, if the tessellation of unit cells (shown in FIGS. 12j and m only along plane x₁-x₂ for visual simplicity) allows connection only at the peaks of the triangular bipyramid, there is no CTE tunability, resulting in α₃=αₛ₂. Thus, the overall effective CTEs of the unit cell in FIG. 12a are expressed as:

$$\{ \begin{matrix}{α}_{1} = {α}_{2} = \frac{{α}_{s 2} cos {θtan}^{- 1} γ + [ {α}_{s 2} - ( {α}_{s 1} + {α}_{s 2} ) {cos}^{2} θ ] \text{/} ξ}{cos θ {tan}^{- 1} γ + ξ} \\ {α}_{3} = {α}_{s 2}\end{matrix} , \qquad ( B14 )$$

where ξ=(1−2 cos² θ)^{1/2}.

Similarly, for the second example in FIG. 12b, TL-1s are replaced by TL-2 building blocks to construct a unit cell with transverse isotropic controllable CTE. A triangular bipyramid core is constructed via six high-CTE stationary lines and three high-CTE bars added in the middle mirror plane. All TL-2s have an identical γ (γ∈(0°, 90°) with γ=75° in FIG. 12b). The symmetry relationship of the building blocks within the unit cell in FIG. 12b is identical to that of TL-1 concept (FIG. 7a), and the unit cell has thermal expansion behavior expressed as:

$$\{ \begin{matrix}{α}_{1} = {α}_{2} = \frac{{α}_{s 1} cos {θtan}^{- 1} γ + ( {α}_{s 2} - 2 {α}_{s 1} {cos}^{2} θ ) \text{/} ξ}{cos θ {tan}^{- 1} γ + ξ} \\ {α}_{3} = {α}_{s 1}\end{matrix} . \qquad ( B15 )$$

The third example in FIG. 12c shows that TN building blocks can also be manipulated to construct a unit cell with transverse isotropic CTE. Six TNs deviate from the vertical direction by γ (γ∈(0°,90°] with γ=90° in FIG. 7c) and round up their high-CTE base members, together with the three high-CTE bars added on the middle mirror plane, to form the edges of a central polyhedron. FIG. 12i shows the unit cell in a 3-fold rotational symmetry, analogous to a trigonal crystal, resulting in only two independent components in the CTE tensor, α₁ and α₃. Within the horizontal plane, the concept has in-plane isotropic CTE tunability (α₁=α₂). The out-of-plane tessellation (along plane x₁-x₂ in FIG. 70) reveals a mere connection via the high-CTE cores, yielding α₃=αₛ₁ with no CTE tunability in the vertical direction. For this reason, the thermal expansion behavior of the unit cell in FIG. 12c is expressed by:

$$\{ \begin{matrix}{α}_{1} = {α}_{2} = \frac{( 3 {α}_{s 2} - 4 {cos}^{2} {θα}_{s 1} ) \text{/} ζ + {α}_{1} cos θ}{2 \sqrt{3} {cos}^{2} θ + ζ} \\ {α}_{3} = {α}_{s 1}\end{matrix} , \qquad ( B16 )$$

where ζ=(3−4 cos² θ)^{1/2}.

We remark that the top views shown in FIGS. 12j, 12k, and 12l are the 3D analogues of previous 2D concepts (Wei et al., 2016). The assembly of other spatial unit cells can be inspired by other 2D cell topologies in the literature (Miller et al., 2008; Steeves et al., 2007). Furthermore, as shown in the examples of Appendix A, the vertical direction (x₃) can also possess CTE tunability by decreasing the deviation angle, γ. FIGS. 12p, 12q, and 12r show the omnidirectional CTEs of the concepts in a spherical coordinate system. A central horizontal plane circularly shaped (dark blue in FIGS. 12p to 12r) shows principal directions with CTE tunability for each transverse isotropic concept. Contour plot symmetry in FIGS. 12p to 12r also reflects the symmetry in thermal expansion, such as no CTE tunability is viable in the vertical direction.

2.3.3. Isotropic CTE Requirement

FIG. 13a-13r show three unit cells, one for each row, possessing isotropic controllable CTE, with TL-1s, TL-2s, and TNs as their building blocks respectively. A regular octahedron core is constructed by either stationary lines of TL building blocks or high-CTE base triangles of TNs. This monolithic core has a uniform thermal expansion in all directions and connects all building blocks via identical distance to the center of each unit cell for given angular space. All the unit cells have a cubic envelope as the unit cell domain. Along the four body diagonal directions of the cubic domain, four 3-fold axes can be found for each unit cell (FIGS. 13g, h, and i), thus showing a cubic symmetry. Analogous to the cubic crystal, there is only one independent coefficient in the CTE tensor of each concept, and therefore each unit cell has identical thermal expansion in all directions. Hence, the tessellated periodic lattices, with all unit cells connected by either stationary nodes or stationary lines (FIG. 13j to o), feature a CTE that is isotropic with adjustable magnitude given by:

$$\begin{matrix}{α}_{Iso - TL - 1} = \frac{{α}_{s 2} cos θ + [ {α}_{s 2} - ( {α}_{s 1} + {α}_{s 2} ) {cos}^{2} θ ] \text{/} ξ}{cos θ + ξ} , for FIG . 13 \text{-} a ; & ( B17 ) \\ {α}_{Iso - TL - 2} = \frac{{α}_{s 1} cos θ + ( {α}_{s 2} - 2 {α}_{1} {cos}^{2} θ ) \text{/} ξ}{cos θ + ξ} , for FIG . 13 \text{-} b ; & ( B 18 ) \\ {α}_{Iso - TN} = \frac{{α}_{s 1} \sqrt{2} cos θ + ( {α}_{s 2} - 4 \text{/} 3 {α}_{s 1} {cos}^{2} θ ) \text{/} ζ}{\sqrt{2} cos θ + ζ} , for FIG . 13 \text{-} c . & ( B 19 )\end{matrix}$$

The unit cells examined in FIG. 13a-13r are some among many other possibilities. FIG. 7d shows another example of a unit with isotropic CTE tunability, previously studied in the literature (Steeves et al., 2007); this cell has an analogous spatial structure of carbon atoms in a diamond, i.e. cubic symmetry. More examples are shown in Appendix A. FIG. 13p to r indicate the omnidirectional CTEs of the concepts in a spherical coordinate system. Evidently, the isotropic CTEs are described by monocoloured spheres, reflecting the symmetry in thermal expansion. The principal directions can be randomly selected within the entire spherical space, yet obtaining the identical lowest CTE for each unit cell.

2.3.4 Geometrical Constraints of Compound Unit Cells

For the nine concepts illustrated in FIGS. 11a to 13r, the effective CTEs in the CTE tunable direction can be programmed through a change of the skew angle, θ, of the building block. The range of θ is restricted by certain values that preserve the tetrahedral shape of the building block, as well as avoid causing collision between adjacent unit cells during thermal expansion. For concepts with transverse isotropic CTE, the range of θ is also governed by γ. Tab. 2 shows the allowable range of θ for each cell topology with φ representing the packing factor of the lattice. A packing factor correlates to a given tessellation. For example, a packing factor of 100% is shared by the unit cells shown in FIG. 6m, n, and o. In contrast, for the unit cells with isotropic CTE given ranges of their skew angles result in tessellations with lower packing factors, such as 50% for the tessellation shown in FIG. 13o (θ=60°). Differences in the packing factor are controlled by the requirement of the inner polyhedron, e.g. octahedron in FIG. 8c, to thermally expand without touching adjacent cells.

| | Unidirectional | Transverse Isotropic | Isotropic |
|---|---|---|---|
| TL-1 and | (45°, 90°) φ = 100% | $( 4 {5}^{°} , {arccos ( 1 + {csc}^{2} γ )}^{- \frac{1}{2}} ] , ϕ = 50 \%$ | (45°, arccos (\sqrt{3}/3)] φ = 50% |
| TL-2 | | | |
| | | $( {arccos ( 1 + {csc}^{2} γ )}^{- \frac{1}{2}} , 9 {0}^{°} ) , ϕ = 100 \%$ | (arccos(\sqrt{3}/3), 90°) φ = 100% |
| TN | (30°, 90°) φ = 100% | $( 3 {0}^{°} , {arccos ( \frac{{( 3 - cos γ )}^{2}}{3 {sin}^{2} γ} + \frac{4}{3} )}^{- \frac{1}{2}} ) , ϕ = 50 \%$ | (30°, 60°], φ = 50% |
| | | $( {arccos ( \frac{{( 3 - cos γ )}^{2}}{3 {sin}^{2} γ} + \frac{4}{3} )}^{- \frac{1}{2}} , 9 {0}^{°} ) , ϕ = 100 \%$ | (60°, 90°), φ = 100% |

2.3.5. Summary Points for Prescribing Thermal Expansion in Spatial Lattices

There are plentiful ways to construct 3D lattices from tetrahedral building blocks. Below, the key notions explained above are summarized to help assemble tetrahedron-based lattices that can meet given magnitude and directional requirements of thermal expansion. The distinguishing features are the building blocks with the definition of their ML and TD vectors, and the symmetry construction operations used to assemble them in the repeating unit.

Building blocks with their thermal expansion. The bi-material tetrahedron is the smallest building block chosen here for generating a periodic 3D lattice. Nine relevant material permutations are available (FIG. 8b to j), among which the most practical are those with stationary lines, TL-1 and TL-2, and with stationary node, TN. For each of them, the material length vector, ML, and the thermal displacement vector, TD, provide a visual and handy description of the magnitude and direction of their thermal expansion. They assist in meeting requirements of given CTE magnitude and closed form expressions are given in section 2.2 to quantify them.

Unit cell construction for prescribed CTE behaviour. Building blocks can be used to assemble complex compound units either with unidirectional CTE tunability (e.g. FIG. 11a) or with a number of tunable CTE directions (e.g. FIG. 13c), as prescribed by the application requirements. The crystal systems in Tab. 1 can assist their arrangement to satisfy directional requirements. If the symmetry relations of one crystal system transfer to the geometrical arrangement of building blocks in a unit cell, analogously the independent tensor components of that crystal system return into the CTE tensor of the overall lattice. Here, the tensor components of the unit cell represent the CTEs in the principal directions, either with or without CTE tunability, of the overall lattice. By following this strategy the overall thermal expansion of a spatial lattice built from compound units can be assessed through the ML and TD vectors of its constitutive building blocks (section 2.2).

In this summary, we also remark that unit cell construction should also meet tessellation requirements, such as those ensuring minimum static and kinematic determinacy, among others. If the assembly process leads to an unstable mechanism, additional members are necessary to lock in any mechanism, and additional struts can be inserted to match the CTE of its surrounding elements so as to avoid altering the direction(s) of CTE-tunability. In addition, because there are multiple tetrahedral building blocks and numerous relations of symmetry to choose from, the number of 3D tessellations capable of satisfying given CTE requirements can be countless. This work has presented nine of them (FIGS. 6 to 8) obtained by implementing the scheme presented here, and the following section describes their proof-of-concept fabrication and thermal testing. Additional concepts showing the viability of the method are given in Appendix A.

3. Fabrication and Experimental Validation

3.1. Component Materials

This section presents the fabrication and CTE testing of i) the building blocks, TN and TL-2, made from metallic constituents, and ii) the nine lattice concepts shown in FIGS. 11a to 13r, made from polymers. The six constituent materials selected are: Al6061, Ti-6Al-4V, and Invar-36 as metallic constituents; and acrylic, Teflon® PTFE, and ABS as polymer constituents. Tab. 3 shows their relevant properties.

| Material | Al 6061 | Ti-6Al-4V | lnvar-36 | Acrylic | PTFE | ABS |
|---|---|---|---|---|---|---|
| Young's | 70.8 | 113.8 | 140.0 | 3.2 | 0.475 | 2.6 |
| modulus (GPa) | | | | | | |
| CTE | 23.0 | 11.5 | 1.5 | 67.0 | 123.0 | 94.5 |
| (×10⁻⁶/° C.) | | | | | | |

Accordingly, as can be seen above, a building block composed of aluminum (as the high CTE element) and titanium (as the low CTE element) will have a relative difference in CTE between the two constituent materials of about 11.5×10-6/° C. A building block composed of PTFE (as the high CTE element) and acrylic (as the low CTE element) will have a relative difference in CTE between the two constituent materials of about 56×10-6/° C. A building block composed of aluminum (as the high CTE element) and Invar (as the low CTE element) will have a relative difference in CTE between the two constituent materials of about 21.5×10-6/° C. A difference a difference in CTE between the first (high) CTE of the first material and the second (low) CTE of the second material may therefore said to be between 10×10⁻⁶/° C. and 60×10⁻⁶/° C.

3.2. Engineering of Specimens

3.2.1 Fabrication of Building Block Samples

Testing samples of building blocks were fabricated via pin-jointed metallic bars (FIG. 9a to d). Ti-6Al-4V shafts (low-CTE) were cut and sanded to the desired length (FIGS. 9b and d) with each end shaped into a crevice. A flake in the shape of a ring tongue terminal was fastened in the crevice of bars by interference fit and strengthened via administering epoxy glue (LePage Epoxy Gel, Henkel, Canada) to serve as a hinge axle sleeve for pinned joints. As shown in FIG. 9, Al6061 shafts (high-CTE) are thicker (diameter of 6.4 mm) than the Ti-6Al-4V bars (diameter of 3.2 mm) so as to construct a stable base with through-holes drilled directly to serve as hinge axle sleeves. All the high CTE bars have given length of 50 mm (FIGS. 9b and d), and the length of low-CTE bars vary for modifying the skew angle at given values. Then the assembly of the different tetrahedral samples were completed using bolts, screw nuts and washers. Since only rotation occurs and no bending moment appears at the joints, the tested CTE of pin-jointed building blocks are validated via closed-form equations in section 2.3 relying on the pin-jointed assumption. Furthermore, in the fabricated prototypes shown in FIG. 14a-14h, the length of the flakes (totalling about 12 mm at both ends), compared with the typical length of the shaft (about 40 to 55 mm), is not negligible. Thus, the thermal effect of flakes on the overall effective CTE of lattices is taken into account to amend the analytical model as further explained in Appendix B.

3.2.2 Fabrication of Unit Cell Specimens

To ease the understanding of the spatial arrangement of building blocks in all unit cells, we built ball-and-stick models as proof-of-concepts (FIGS. 11a to 13r). Connection balls (10 mm diameter) have several blind holes (with a 1.6 mm diameter and 2 mm depth) in different orientations on the surface (FIG. 14g) to connect sticks (FIGS. 14e and 14f). All the spheres are 3D printed (printer: Original Prusa i3 MK2) by ABS. The sticks were laser cut into different lengths, all from 1.6-mm-diameter rods made from either PTFE (high-CTE) or acrylic (low-CTE). Both ends of the sticks were plugged into the blind holes of spheres and then rigidly fixed by resin glue (LePage Epoxy Gel, Henkel, Canada). The thickness of the resin adhesive layer was very thin making the thermal expansion of resin glue negligible. In contrast, the ABS connection ball had a non-negligible thermal expansion, and this deviation is considered in a later section validating experimental measures against theoretical and simulation results.

Moreover, since the CTE properties of the concepts here introduced are primarily dependent on the unit cell geometry besides the CTEs of the constituent solids, the principles can be applied to systems across a wide range of length scales, and hence fabricated with both conventional and advanced methods. Additive manufacturing is a viable method that can be effortlessly used to assemble in large volume bi-material lattices with smaller element size, as demonstrated by recent works appeared in the literature on this topic.

3.3. Experimental Method

Both tetrahedral building blocks (FIG. 14a-14h) and compound unit cells (FIGS. 11a to 13r) were experimentally investigated to validate their CTEs. For the former, 12 physical samples were tested to verify the respective theoretical models of TL-2 and TN building blocks (Eqs. (9) and (10) in section 2.2.1) with two dissimilar pair of material combinations and three different skew angles (see Appendix B for the images of the physical samples of the building blocks). The first material combination consisted of Al6061 and Ti-6Al-4V (i.e. Al/Ti), and the second consisted of Al6061 and Invar (i.e. Al/Invar). In all cases, Al was the high CTE material while Invar and Ti were the low CTE materials. The three skew angles of the building blocks for each material combination varied between 53° to 65° with approximately equal angle difference. For example, if the 12 samples were organized into four sets of three, the first set would consist of three TL-2 samples made from Al/Ti with skew angles 53.5°, 61.7° and 63.7°, respectively. Besides building blocks, nine physical samples of the compound unit cells were tested, one for each of the concepts shown in FIG. 11a to 13r. The skew angles of all samples were set to 60°, and the CTEs along the principal directions were measured by assessing the relative thermal displacement of the connection balls.

3D DIC tests were performed to measure the thermal displacement of all samples with randomly distributed black and white pattern painted on the surface (FIG. 14h). DIC testing consists of capturing images, before and after heating the sample within a heating chamber, at selected temperatures so that elongation can be measured. Testing temperature was monitored and managed from 25° C. to 75° C. (for polymer samples) or to 150° C. (for metallic samples) through a PID (proportion-integration-differentiation) controller (CN7800, Omega, US). A data acquisition system (NI cDAQ 9174) was used to measure the temperature heterogeneity via collecting three thermocouples from different locations in the chamber. The temperature heterogeneity was regulated within 5% of the real-time temperature through the application of a rotational air fan. DIC system calibration ensured an epipolar projection error below 0.01 pixel, i.e. the average error between the position where a target point was found in the image and the theoretical position where the mathematical calibration model located the point. Two CCD (charge coupled device) cameras (PointGrey, Canada) were used to focus on an area of 240×200 mm² with a resolution of 2448×2048 pixel; based on the image resolution, any deformation smaller than 0.98 μm (0.01 pixel) was merged with the epipolar projection error. Using the DIC correlation software, Vic-3D (Correlate Solution Inc.), virtual extensometers were placed on the reference image and tracked through the images to measure the displacement between pairs of pixel subsets. The thermal deformation field (FIG. 10) was obtained from the relative displacement between these pairs of subsets. The effective CTE was calculated from thermal strain and temperature change. Finally, the accuracy of the whole testing system was verified with CTE measurements of a solid material, Al6061, taken from a commercial thermomechanical analyzer, TMA Q400 (TA Instrument, US). A comparison of their measured (22.6×10⁻⁶/° C.) and DIC predicted mean CTE (23.0×10⁻⁶/° C.) shows an error of 1.7%. The epipolar projection error is at 0.98 μm, which governs the smallest measured CTE value of the samples, i.e. 0.27×10⁻⁶/° C. Hence, the low magnitude of these errors warrants the required accuracy for the DIC system used in this work.

3.4. Experimental Results

The thermal testing results of both the building blocks and compound unit cells are here compared with results from either numerical analysis or closed-form expressions (FIG. 15a-15b). The role of component materials and skew angle on the effective CTE is emphasized. In addition, the effect of connection type, either pin-joint (building blocks) or rigid-joint (unit cells), is assessed to validate the pin-jointed assumption of the closed-form expressions derived for ideal building blocks and compound unit cells.

A TN, both pin-jointed with similar B and identical components of Al/Ti, are taken as representatives to illustrate the tunable thermal displacement that each tetrahedron can provide along the principal directions. The horizontal thermal displacement shown in FIG. 10 (a and b for TL-2 with θ=61.7°, e and f for TN with θ=63.3°) indicates that for both building blocks, the effective CTE is high and positive (23×10⁻⁶/° C.), identical to that of the high-CTE constituent Al, i.e. no CTE tunability. In the vertical direction of TL-2, the nearly alike light-green color on nodes used for CTE measurement (i.e. nodes B1 and B2 in FIG. 10d) indicates a near zero distance change. Thus, the effective CTE of TL-2 specimen in the vertical direction is almost vanishing (3.70×10⁻⁶/° C.). In contrast, along the vertical direction of TN, the distance between the two corresponding nodes, D1 and D2 in FIG. 10h used for CTE measurement, increases during thermal expansion, which results in a positive effective CTE (8.42×10⁻⁶/° C.), a value below those of its constituents Al (23×10⁻⁶/° C.) and Ti (11.5×10⁻⁶/° C.). Thus for similar skew angle and identical constituents, TL-2 can attain a lower CTE than TN.

In both directions, the thermal distribution of the former made of Al and Ti, parallel that of the latter, made of acrylic and PTFE, despite the difference in magnitude caused by each given pair of constituent materials.

FIG. 15aa illustrates the impact of the skew angle, building block type, and component material on the effective CTE of building blocks. For all sets of samples, the CTE reduces significantly with decreasing skew angle, whereas for high values the CTE is less sensitive; nevertheless, CTE tuning across the range of skew angle here considered can be achieved for both TN and TL-2. In addition, for prescribed pair of materials, i.e. (Al/Ti) and (Al/Invar), the red and green curves show the CTE trend of TN with respect to the skew angle, and the blue and violet curves that of TL-2. The results show that the CTE of TL-2 can be tuned to a smaller value than that of TN, hence the ΔCTE of TL-2 is larger in the given range of skew angle. Another insight that can be gained from FIG. 15a pertains to the role of the CTE ratio of the constituents, i.e. λ=αₛ₁/αₛ₂. The greater the CTE distinction of the constituent solids (γ_{Al-Invar}≈% 15.3 which is higher than λ_{Al-Ti}=2.0), the larger the CTE tunability of a building block. We also remark that the largest negative CTE a building block can reach in all experiments of this work is −26.2×10⁻⁶/° C. (Al/Invar TL-2 with θ=54.1°) which is well below the CTE values of its components.

FIG. 15b compares the experimental (specimens with rigid-joints) and theoretical (closed-form expressions with pin-joints) results for the CTE of all the compound units. The relatively small errors associated with the testing results, which go as high as 6.3%, validate the CTEs under pin- and rigid-joint assumptions displaying small deviations, hence respecting the small deformation assumption. Another insight concerns the effective CTE of the building blocks here investigated. As shown in FIG. 15b, comparing the three concepts with unidirectional CTE tunability (i.e. specimens 1, 2, and 3 in FIG. 15b), specimens with stationary lines (TL-1 and TL-2) have smaller effective CTE values than that of specimens with stationary nodes. The conclusion up to this point is summarized as TL concepts have larger CTE tunability than TN concepts which also applies to the concepts with identical transverse isotropic or isotropic CTEs. The comparison between three concepts made of TL-1s (i.e. specimens 1, 4, and 7 in FIG. 15b), or other concepts made of the identical building block, show an increase in the effective CTE when the CTE-tunable directionality increases from unidirectional (one principal direction) to transvers isotropic (two principal directions) and then to isotropic CTE (three principal directions). An increase of CTE-tunable directionality is accompanied by the presence and size increase of the monomaterial core of concepts. For example, unidirectional cells contain no monomaterial core, but transverse-isotropic cells have small cores compared to isotropic cells' large cores. The presence and size of a monomaterial core make the effective CTEs increase with the size of the core. However, TL-2 concepts are more significantly affected by the high-CTE (red) cores than TL-1 concepts with low-CTE (blue) cores. Thus in FIG. 15b, with a triangular bipyramid core, specimen 4 has a larger CTE than specimen 5, while in contrast, specimen 7 has a smaller CTE than specimen 8 when an octahedron core is constructed for the isotropic concepts. The fabrication and testing method reported in this work can also be applied to building blocks with effective CTEs higher than that of the constituents (i.e. high-CTE cases as shown in FIG. 8a-8k) as well as concepts with more complex architecture.

4. Mechanical Properties

To understand how a programmable CTE truss-system behaves as a bulk material with effective properties, we adopt here a classical continuum-based approach that relates the stress-strain behaviour of the unit cell to that of the global level. In doing so, we assume that the characteristic length of the unit cell is at least one or two orders of magnitude below the characteristic length of the truss-system. This scale separation between the global response and that of the unit cell allows us to calculate the effective properties through a continuum model (Arabnejad and Pasini, 2013). For three dual-material unit cells with unidirectional CTE tunability (TL-1, TL-2 and TN concepts shown in FIG. 11a-11r), we present in the main body of the text closed-form expressions of their elastic properties, and in Appendix E their buckling and yielding strength. For unit cells with transverse isotropic or isotropic CTEs (concepts shown in FIGS. 12a-13r), a numeric approach is used to obtain their elastic properties.

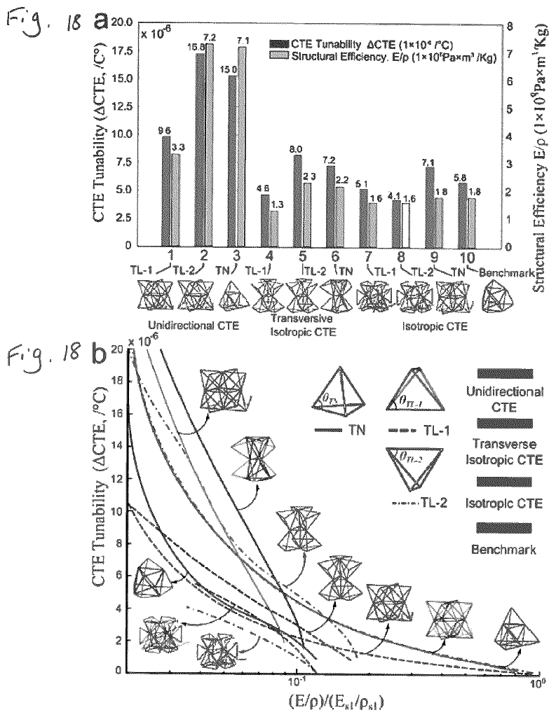

Thermal expansion. The CTE of bi-material lattice materials depends on the CTE mismatch of materials, the skew angle, i.e. the interplay of the structural members, as well as the stiffness mismatch of materials and joints. FIG. 17 reveals the role of the skew angle in the thermal expansion performance of each low-CTE unit cell. As a general trend, we observe that as the skew angle increases from the minimum to the maximum value of range (Tab. 2), the CTEs for all units converge gradually to that of the low-CTE solid material (10×10⁻⁶° C. in FIG. 17). The similar upper bound indicates the largest ΔCTE comes from the concept obtaining the lowest CTE value. As shown in FIG. 17, with a given range of skew angles and given directional behaviour (i.e. unidirectional, transverse isotropic, or isotropic), the lowest effective CTE a TL-1 and TL-2 concept can achieve is generally lower than that of the TN concept. This demonstrates that concepts with stationary lines have a better CTE tunability, because the CTE tunability of TL-1 and TL-2 building blocks is higher than that of the TNs (FIG. 9a-9i). Similarly, when comparing TL-1 with TL-2 concepts, the latter has generally a larger ΔCTE, especially for concepts with small or no monomaterial core (i.e. transverse-isotropic and unidirectional, respectively). However, for isotropic concepts, above θ=53° TL-2 has higher CTE values than TL-1, as the influence of TL-2 high-CTE octahedron core is far larger than that of the low-CTE core of the TL-1 concept. For lattices assembled with a given building block, TL-1, TL-2, or TN, the CTE tunability is often the smallest for unit cells with isotropic CTE, followed by unit cells with transverse isotropic CTE. This can also be attributed to the influence of larger single-material core (octahedron) of isotropic-concepts than the core (triangular bipyramid) of the transverse-isotropic concepts; the former is more effective in counteracting the CTE tunability via larger monomaterial core and hence impairing CTE tunability. On the other hand, the largest CTE tunability in the principal direction can be achieved by unit cells which have unidirectional CTE with no monomaterial core.

The experimental results in section 3.4 show that the CTEs under the pin- and rigid-jointed assumptions deviate marginally from each other. Under the pin-jointed assumption, the stiffness mismatch of the component materials has no effect on the effective CTE, as opposed to the case of the rigid-jointed assumption, where the stiffness mismatch of the components can play a role on CTE tunability. A relative comparison between the three factors here examined shows that the effect of the stiffness mismatch is secondary to the influence of the other two, namely the interplay of structures and the CTE mismatch of materials. Appendix A reports additional results on the CTE of rigid-jointed bi-material lattices obtained for a number of Young's modulus ratio of the constituent solids.

Specific stiffness. The specific stiffness of all concepts increases linearly with the relative density ρ*. For increasing the skew angle θ with constant ρ*, the Young's modulus is also observed to raise for unidirectional concepts while a parabolic effect appears for the remaining concepts (e.g. FIGS. 17f and 17i), i.e. a rise is followed by declining modulus. This can be attributed to the changing alignment of the high-stiffness component (i.e. low-CTE Ti bars) along the loading direction: i) for unidirectional concepts, increasing θ results in an incremental alignment along x₃; ii) for both transverse-isotropic and isotropic concepts, the same incremental alignment is initially experienced along the loading direction, before beginning to deviate from the loading direction above a specific θ value. The parabolic effect can also be observed for FIG. 15d, e, g, h, and j when a larger range of θ is plotted.

For given ρ* and θ, FIGS. 17a-17j highlights also similarities between the stiffness of TL-1 and TL-2 concepts. Compared to TL-2 concepts, TL-1 concepts feature slightly higher values of specific stiffness, due to presence of more Ti bars. However, TN concepts generally outperform the others in stiffness, especially for transverse-isotropic (17f) and isotropic concepts (FIG. 17i) where the parabolic effect is observed at θ≈60°, resulting in a much higher specific stiffness than TL concepts with identical θ, ρ*, and CTE directionality. FIG. 17j plots also the specific stiffness values for the benchmark (Steeves et al., 2007). Compared to this baseline, we notice that unidirectional and transverse-isotropic concepts produce higher stiffness along the direction of CTE tunability, but the isotropic concepts are comparable for given geometric and constituent parameters.

Trade-Off Between CTE Tunability and Specific Stiffness.

The results above give an indication of existing trade-offs between the properties of the concepts here studied: ΔCTE and specific stiffness. To better understand these trade-offs, FIG. 18a shows bars of ΔCTE and specific stiffness simultaneously, and in FIG. 18b ΔCTE is plotted versus specific stiffness to demonstrate Pareto-fronts, both for all concepts made of Al and Ti.

For FIG. 18a, the ΔCTE bars are calculated for all concepts under a given stiffness value (1 GPa), while bars of structural efficiency are all derived from concepts with equal CTE (6.5×10⁻⁶/° C.), a value lower than the CTE of their base materials: Al/Ti). This allows for a consistent comparison of their thermo-elastic performance. The bars are arranged in order of increasing number of CTE tunable principal directions, from unidirectional to isotropic concepts. Evidently, with increasing number of CTE tunable directions, there is a penalty in both ΔCTE and structural efficiency. The decrease in ΔCTE is due to the presence and increasing size of monomaterial cores, as previously observed. The drop in structural efficiency, however, is attributed to the distribution of load bearing bars along the CTE tunable directions, thus resulting in a more uniform load capacity, but with lower effective stiffness along a specific direction. For unidirectional and transverse-isotropic concepts, TL-2 unit cells provide the best ΔCTE and specific stiffness values, followed closely by TN concepts, while both performing significantly better than TL-1. However, for isotropic concepts, the TN thermo-elastic performance exceeds that of TL-2, due to the reduced performance of the TL-2 core.

The Pareto-front curves shown in FIG. 18b are generated from a parametric study of the unit cells, where the skewness angle and the thickness-to-length ratio are the active variables for given materials (Al/Ti). The curve shapes emphasize the trade-offs between the two metrics plotted: an attempt of increasing structural efficiency results in a reduced ΔCTE. This common trend demonstrates that the desired deformation that a large CTE tunability would require is generally antagonist to the high specific stiffness that is distinctive of a structurally efficient architecture. Here we notice that unidirectional concepts excel in structural efficiency along their CTE tunable direction; but for increasing ΔCTE, their specific stiffness drops. Transverse-isotropic unit cells are unable to attain the highest level of specific stiffness, but, within their attainable range, they generally provide higher ΔCTE compared to unidirectional concepts. Finally, for isotropic concepts, including S-concept (Steeves et al., 2007), there is a sacrifice in both ΔCTE and structural efficiency, except for the isotropic TN unit cell, which maintains performance similar to its transverse-isotropic counterpart. Overall, FIGS. 18a and 18b provides a comprehensive comparison of the thermo-elastic performance of the concepts here examined, bearing in mind that no CTE directionality is ultimately superior to the rest as the direction of CTE tunability is entirely dependent on the application requirements.

In certain embodiments described herein, three groups (low-CTE, intermediate-CTE, high-CTE) are introduced for the tetrahedral building block to tune the effective CTE at values that can be lower, in between, or higher than the constituent material CTEs. For the low-CTE group, three specific mechanisms are identified for a bi-material tetrahedron: two with stationary-lines, and the third with a stationary-node. Additionally, a systematic method to rationally assemble building blocks into compound units, such as the nine here introduced, is described herein that can attain desired magnitude and directionality of thermal expansion in three-dimensional lattices. Further, means for resolving the trade-off between CTE tunability and specific stiffness, which has led to the assembly of building blocks into stiff and strong, yet high CTE tunable spatial lattices with application across the spectrum of length scale, are also provided.

Bi-material lattices built from tetrahedral building blocks such as to permit predetermined thermal expansion are thus described above. The material length vector and thermal displacement vector are first defined to assess thermal expansion of truss concepts, and then used to examine all the possible material permutations that can occur in the struts of a dual-material tetrahedron. The results establish underlying principles governing tailorable thermal expansion in dual-material lattice materials, where desired CTE magnitude and spatial CTE directionality can be programmed a priori to satisfy given CTE requirements, such as unidirectional, transverse isotropic, or isotropic. This works has also shown that three-dimensional lattices can be systematically assembled with high specific stiffness to attain large CTE tunability over a substantial range of temperature, thus appealing to a large palette of applications where low mass, thermal stability and thermal actuation are primary goals.

Two dual-material tetrahedra with CTE tunability that can thus be used to generate six supplementary unit cells with given CTE behaviour. The first tetrahedron (Fig. A1a) has low-CTE tunability in the vertical direction with shear thermal deformation during expansion. The second tetrahedron, intermediate tetrahedron, is able to obtain the effective CTE of a value between the CTEs of the two components only. The additional concepts shown in Fig. A1 can not only obtain transverse isotropic and isotropic CTE, as with concepts shown in FIG. 12a-12r and FIG. 13a-13r, but also orthotropic CTE. The unit cell has CTE tunability in both the x₁ and x₃ directions with different magnitudes. With the x₂ direction exhibiting no CTE tunability, the concept overall demonstrates orthotropic CTE tunability.

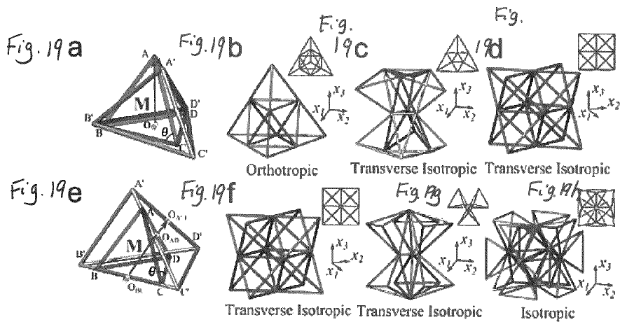

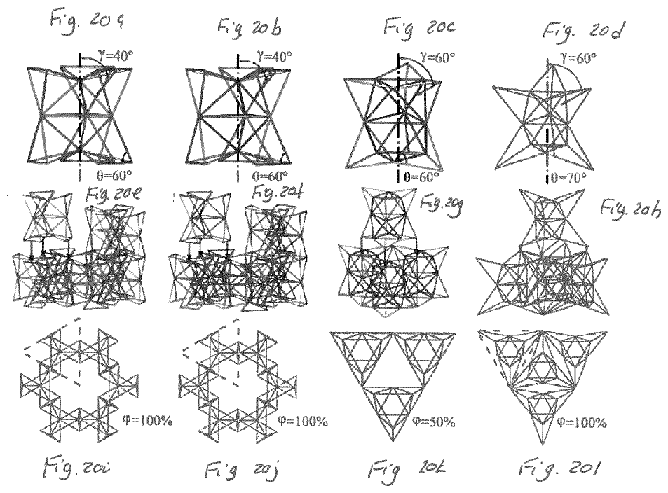

The effective CTE of the dual-material tetrahedra shown in FIGS. 19a and 19e (M direction) can be expressed respectively as:

$$\begin{matrix}{α}_{z - L 4 H 2} = \frac{16 {α}_{s 1} {cos}^{2} θ - {α}_{s 2}}{16 {cos}^{2} θ - 1} , θ ∈ ( 15 ° , 75 ° ) , & ( A .1 ) \\ {α}_{z - L 3 H 3} = \frac{4 {α}_{s 1} {cos}^{2} θ + {α}_{s 2}}{4 {cos}^{2} θ + 1} , θ ∈ ( 36 ° , 72 ° ) . & ( A .2 )\end{matrix}$$

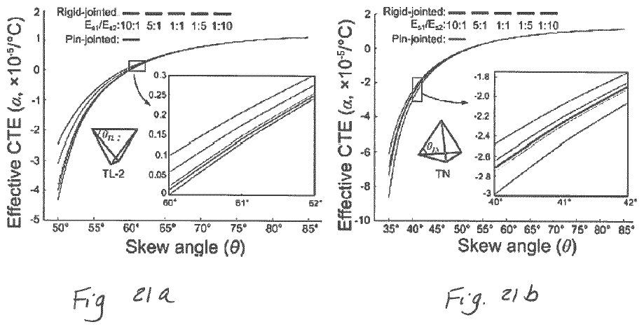

FIG. 20a-20l shows unit cells with transverse isotropic CTE governed by the deviation angle, γ, and the skew angle, θ. The decrease of γ and increase of θ allow the connection of unit cells (FIGS. 20a to 20d) in the out-of-plane principal direction via only stationary lines or stationary nodes. In contrast with concepts shown in FIG. 7, which have no CTE tunability in the vertical direction, concepts in FIGS. 20a to 20d have CTE tunability in all three principal directions. Comparison of concepts depicted in FIGS. 20c and d shows the effects of γ and θ on the packing factor, φ. Differences in the packing factor are controlled by the need of the inner octahedron to thermally expand without touching adjacent cells (FIGS. 20k and 20l). A packing factor of 50% could be obtained for tessellation in FIG. 20k. In contrast, dissimilar skew angles for the concept in FIG. 20d results in a tessellation with higher packing factors, i.e. 100%.

In the following we assess the effect of the stiffness mismatch of materials and joint assumption.

FIG. 21a-21b visualizes the effective CTE in the vertical direction for rigid-jointed TL-2 and TN concepts with unidirectional CTE tunability, here chosen for demonstrative purposes. Both the skew angle and the Young's modulus ratio Eₛ₁/Eₛ₂ of the components (i.e. Young's moduli of high-CTE material over low-CTE material) play a role in the effective CTE but to a different extent. The effect of the stiffness mismatch of materials is secondary compared to that caused by a change in the skew angle, i.e. the interplay of structures. The former has a non-negligible influence only at low values of the skew angle (e.g. below θ=50° for TL-2 concept, and below θ=35° for TN concept). If the low-CTE material has a larger Young's modulus (i.e. Eₛ₁<Eₛ₂), an increase in Eₛ₁/Eₛ₂, i.e. the Young's modulus ratio of the components, reduces the effective CTE to a lower value; this phenomenon is caused by the high-CTE elements inducing a larger compensation of thermal expansion with increased stiffness. In contrast, if the high-CTE material has a larger Young's modulus (i.e. Eₛ₁>E_{Ω}), the impact of the stiffness mismatch of materials on the effective CTE is negligible.

As can be understood, the examples described above and illustrated are intended to be exemplary only. The scope is indicated by the appended claims.

1. A metamaterial having a programmed thermal expansion when exposed to a temperature condition, the metamaterial comprising a lattice structure composed of a plurality of interconnected unit cells, each of the unit cells comprising two or more bi-material building blocks, each of the bi-material building blocks including one or more first material elements and two or more second material elements, the first material elements having a first coefficient of thermal expansion (CTE) and the second material elements having a second CTE, the first CTE being greater than the second CTE, the bi-material building blocks having a topology each having two or more vertices formed at junctions between said first material elements and said second material elements, one of the first material elements interconnecting and extending between two of the second material elements at said vertices of the topology, said one of the first material elements having the first CTE deforming substantially long a longitudinal axis thereof to cause the bi-material building blocks to be stretch-dominated when deforming in response to temperature changes, and wherein the bi-material building blocks and the unit cells are inter-engaged and tessellated to provide the lattice structure with the programmed thermal expansion when exposed to the temperature condition.

2. The metamaterial as defined in claim 1, wherein the bi-material building blocks have a triangular, diamond or tetrahedron shaped topology formed by said first material elements and said second material elements.

3. (canceled)

4. The metamaterial as defined in claim 1, wherein the lattice is two-dimensional and the topology of the bi-material building blocks includes a diamond shaped topology, and said one of the first material elements extends transversely through the diamond shaped topology to interconnect two minor vertices thereof.

5. The metamaterial as defined in claim 1, wherein the lattice is three-dimensional and the topology of the bi-material building blocks includes a tetrahedron shaped topology.

6. The metamaterial as defined in claim 5, wherein said one of the first material elements forms at least one edge of the tetrahedron shaped topology.

7. The metamaterial as defined in claim 1, wherein the first material elements and the second material elements forming the bi-material building blocks are rods that are interconnected at opposed ends thereof to form said topology, and the opposed ends of each of the rods are pivotably interconnected at the vertices of the topology.

8. (canceled)

9. The metamaterial as defined in claim 1, wherein the lattice is two-dimensional and the topology of the bi-material building blocks includes a diamond shaped topology, each of the diamond shaped bi-material building blocks is composed of five rods, at least one of the five rods being made of the first material elements having the first CTE and the remaining rods being made of the second material elements having the second CTE that is lower than the first CTE.

10. The metamaterial as defined in claim 9, wherein an internal angle defined between said at least one of the five rods made of the first material elements and at least one adjacent of the remaining rods made of the second material elements defined at a vertex therebetween is between 55 and 65 degrees.

11. The metamaterial as defined in claim 9, wherein only one of the five rods is made of the first material element having the first CTE.

12. The metamaterial as defined in claim 9, wherein each of the five rods is pivotably connected at ends thereof to adjacent ends of two of the remaining rods.

13. The metamaterial as defined in claim 5, wherein each of the tetrahedron shaped bi-material building blocks is composed of six rods connected together to define the tetrahedron shaped bi-material building block having four faces, at least one of the six rods being made of the first material elements having the first CTE and the remaining rods being made of the second material elements having the second CTE that is lower than the first CTE.

14. The metamaterial as defined in claim 13, wherein only one of the six rods is made of the first material element having the first CTE, and each of the six rods is pivotably connected at ends thereof to adjacent ends of two of the remaining rods.

15. (canceled)

16. The metamaterial as defined in claim 1, wherein each of the bi-material building blocks includes only one of the first material elements having the first CTE, a remainder of the topology of the bi-material building blocks formed by the second material elements having the second CTE.

17. The metamaterial as defined in claim 1, wherein the lattice structure is a hierarchical lattice having between one and three orders of hierarchy.

18. The metamaterial as defined in claim 17, wherein the hierarchical lattice is a hybrid-type hierarchical lattice, the unit cells of the hybrid-type hierarchical lattice including two or more different unit cell topologies.

19. The metamaterial as defined in claim 18, wherein the hybrid-type hierarchical lattice has a skew angle of between 55 and 65 degrees.

20. (canceled)

21. The metamaterial as defined in claim 17, wherein the hierarchical lattice is a fractal-like hierarchical lattice, with self-repeating ones of the unit cells and/or the building blocks forming a replication motif of the fractal-like hierarchical lattice

22. (canceled)

23. The metamaterial as defined in claim 13, wherein each of the four faces of the tetrahedron shaped bi-material building block is defined by three of the six rods, and wherein an orientation of each of the four faces defining a local direction of CTE tunability.

24. The metamaterial as defined in claim 9, wherein the five rods include four diagonal rods connected to one another at their extremities to form the diamond shaped topology, each of the four diagonal bars having said first CTE, and a transverse rod extending between extremities thereof and interconnecting two vertices of the diamond formed by the four diagonal rods by, each extremity connected to opposed connections of the four diagonal rods, the transverse rod having the second CTE that is less than the first CTE.

25. The metamaterial as defined in claim 1, wherein a ratio of the first CTE to the second CTE is between 0.1 and 10.

26. The metamaterial as defined in claim 1, wherein a difference in CTE between the first CTE and the second CTE is between 10×10⁻⁶/° C. and 60×10⁻⁶/° C.

27. The metamaterial as defined in claim 1, wherein a range of CTE (ΔCTE), defined between a lowest CTE value of the lattice structure and a CTE of a solid material having lower thermal expansion, is between 100×10⁻⁶/° C. and 550×10⁻⁶/° C.

28. The metamaterial as defined in claim 1, wherein a specific stiffness of the lattice structure, defined as the elastic modulus per mass density thereof, is between 0.00001 and 0.1.

29. (canceled)

30. The metamaterial as defined in claim 1, wherein the first material elements are formed of one of aluminum and alloys thereof and polytetrafluoroethylene (PTFE), and the second material elements are formed of one of titanium and alloys thereof, acrylic, and Invar.

31. A method of forming a metamaterial having a programmed overall coefficient thermal expansion, the method comprising using additive manufacturing to form a lattice structure having a plurality of interconnected unit cells, each of the unit cells comprising two or more bi-material building blocks, each of the bi-material building blocks including one or more first material elements and two or more second material elements, including selecting a first coefficient of thermal expansion (CTE) of the first material elements and a second CTE of the second material elements lower than the first CTE, and selecting a topology for the bi-material building blocks with two or more vertices formed at junctions between said first material elements and said second material elements, and forming the bi-material building blocks such that one of the first material elements interconnects and extends between two of the second material elements at said vertices of the topology, and configuring the bi-material building blocks to have a stretch-dominated thermal response.
